(19) United States
(12) Patent Application Publication
(10) Pub. No.: US 2006/0013289 A1
(43) Pub. Date: Jan. 19, 2006

(54) Multistage adaptive parallel interference canceller

(76) Inventor: In Kwan Hwang, Daejon (KR)

Correspondence Address: LADAS & PARRY LLP, 224 SOUTH MICHIGAN AVENUE, SUITE 1600, CHICAGO, IL, 60604, US

(21) Appl. No.: 10/521,844

(22) PCT Filed: Jul. 16, 2003
(86) PCT No.: PCT/KR03/01412

§ 371 Date: Jan. 18, 2005

(30) Foreign Application Priority Data
Jul. 16, 2002 (KR) 10-2002-0041666
Aug. 6, 2002 (KR) 10-2002-0046317
Aug. 26, 2002 (KR) 10-2002-0050486
Jan. 17, 2003 (KR) 10-2003-0003402
May 30, 2003 (KR) 10-2003-0034783

(51) Int. Cl. H04B 1/707

(52) U.S. Cl. 375/148; 375/152

(57) ABSTRACT

A multistage adaptive parallel interference canceller is disclosed. The multistage adaptive parallel interference canceller for a downlink receiver includes: a plurality of stages of interference cancellation units. Each of interference cancellation units includes: a matched filter for matching a signal from a rake receiver each channel signal and generating a matched signal; a soft decision unit of which a slope is monotonically increased, for performing soft decision of the matched signal and generating a soft-decided signal; a weight controller for controlling the slope of the soft decision unit; a respreader for respreading the soft-decided signal based on a walsh code and a scrambling code and generating a respread signal; an interference calculator for calculating interference signals due to another user signal and multipath signals; and an interference canceller for canceling the interference signals from an input signal received in the rake receiver.

### TECHNICAL FIELD

The present invention relates to a multistage adaptive partial parallel interference canceller which efficiently cancels multiple access interference (MAI) and interpath interference (IPI) in a direct sequence code division multiple access (DS-CDMA) mobile communication system.

### BACKGROUND ART

The performance of the third generation CDMA systems for providing upto 2 Mbps data rate is always degraded by multiple access interference (MAI) and interpath interference (IPI). Also, although orthogonal codes are used, orthogonal characteristics of codes are corrupted on a time varying fading channel and a rake receiver produces more complicated interference for high data rate channels. These also make multi-user detection (MUD) design complicated.

When a multi-rate system is implemented to provide multimedia services to each user, the design of MUD becomes more complicated and it results in the performance degradation of the low data rate channels because a channel having a low data rate experiences severe interference from channels having a high data rate.

In order to overcome the problems, concepts of MUD have been proposed and research results have been presented. The research results include a maximum likelihood sequence (MLS) detector, a linear MUD, a neural network based MUD and a nonlinear MUD.

However, the MLS detector has disadvantages such as exponentially increasing complexity and difficulty of a real-time implementation as the number of users is increased. The linear MUD has great performance at white noise environment, but the performance of the system is degraded on a time varying fading channel. In order to overcome the problem on the time varying channel, the adaptive linear MUDs have been proposed. However, the efficiency of channel usage is degraded because training sequences are required and the time varying characteristic of correlation coefficients among signature waveforms of high data rate channels is too fast to adjust and to estimate in real time.

There are MUDs based on neural network such as Multilayer Cerptron (MLP) or Hopfield Neural Network (HNN). The MLP has disadvantages that the channel efficiency is degraded because training sequences are required and faster back propagation algorithm is necessary as the number of users increases and it results in an increase of the number of neurons. Also, the HNN has a disadvantage that the number of local minimums increases and the global minimum may not be founded, as the number of users increases.

The nonlinear MUD such as Parallel Interference Canceller (PIC) is known to be a practical structure for overcoming the difficulty for estimating the fast time variant correlation coefficients among signature waveforms even though the circuit is complicate. Especially, the multistage parallel interference canceller (MPIC) 15 is recognized as a very efficient device for low data rate channels among MUDS.

FIG. 1 is a block diagram showing a conventional multistage parallel interference canceller (PIC) having hard limiters.

Referring to FIG. 1, r(t) is a signal received by a rake receiver 10 and MAI and IPI are cancelled by a multistage PIC.

FIG. 2 is a block diagram showing an internal structure of the i^{th} interference canceller in FIG. 1. Herein, i denotes the i^{th} interference canceller, and j denotes the j^{th} channel.

Referring to FIG. 2, a hard limiter 20 of each channel performs hard decisions on input signals and generates digital signals such as +1 or −1. The digital signal is re-spread by a Walsh code W(t) and a scrambling code S(t) and inputted to an the interference generator 22.

The interference generator 22 computes total interference signals Iᵢⱼ(t) including MAI as follows.

$$\begin{matrix}\begin{matrix} For j = 1 to 4 and i = 1 to N \\ {z}_{oij} ( t ) = ( {\overline{a}}_{ij} ( t ) {z}_{ij} ( t ) + {\overline{b}}_{ij} ( t - 3 {T}_{c} ) {z}_{ij} ( t - 3 {T}_{c} ) + {\overline{c}}_{ij} ( t - 5 {T}_{c} ) \\ {z}_{ij} ( t - 5 {T}_{c} ) ) \end{matrix} \\ {I}_{ij} ( t ) = {\sum }_{{l = 1}_{l \neq j}}^{4} {z}_{oil} ( t )\end{matrix} \qquad \begin{matrix} \\ Eq . 1\end{matrix}$$

The computed total interference signals Iᵢⱼ(t) are removed from the signal rᵢ(t) inputted to the rake receiver 24 and a signal xᵢⱼ is outputted from the rake receiver 24. Herein, aᵢⱼ(t), bᵢⱼ(t) and cᵢⱼ(t) are tap gains outputted from the channel estimator of the rake receiver 24. That is, aᵢ₃(t), bᵢ₃(t) and cᵢ₃(t) are tap gains of the third user channel in the i^{th} interference canceller.

The matched filter receives the signal x_{i+1,j} outputted from the rake receiver 24, extracts signal components for each channel and outputs the extracted signal components to an i+1^{th} interference canceller. As mentioned above, interference signals are computed more precisely as the number of stages increases and interference cancelled and correctly detected signals for each channel can be obtained by the final parallel interference canceller (PIC).

A performance of the multistage PIC mainly depends on the initial decision of the limiter. If the hard decision at the initial stage is wrong, wrong interference signals are generated and the performance of the multistage PIC is abruptly degraded. That is to say, the error of the initial stage is not removed and continuously affects interference cancellation. Finally, it results in overflow of detected errors.

To overcome the problem mentioned above, multistage partial PICs have been proposed. The multistage partial PIC removes interference signals partially at each stage. That is, a partial PIC adopting hard limiters cascaded to the weighting controllers of which weights are monotonically increased as the stage number increases and the interference generation is controlled by the weights. Instead of the hard limiters, soft limiters can be used and the slope of the soft limiter can be monotonically increased as the stage number increases. Also, the soft limiter cascaded to a weighting controller can be used.

However, it is difficult to optimize the slope of the soft limiter and the weighting value at each stage. Particularly, it is more difficult to optimize the slope of the soft limiter and the weighting value at each stage when a power control is failed or the interference between time varying channels becomes stronger as the number of users increases.

Therefore, the interference canceller which can efficiently remove IPI and MAI of the time varying channels with simple slope control method or weight control method is required.

### DISCLOSURE OF INVENTION

It is, therefore, an object of the present invention to provide a multistage adaptive partial parallel interference canceller (PIC) for removing multiple access interference (MAI) and interpath interference (IPI) on time varying fading channel by adaptively controlling the weights cascaded to the soft limiters.

It is another object of the present invention to provide a multistage adaptive partial PIC for minimizing the degradation of orthogonality among user signals by normalizing the output signals of the rake receiver with the estimated path gains of the rake receiver.

It is still another object of the present invention to provide a multistage adaptive partial PIC for reducing the circuit complexity by storing the output signals of the rake receiver or the matched filter in the memory and repeatedly using the value stored in the memory.

In accordance with one aspect of the present invention, there is provided a multistage adaptive partial parallel interference canceller (PIC) in a downlink receiver having a plurality of channels, for removing multiple access interference (MAI) and interpath interference (IPI), including: a filter matched to a desired walsh code and a scrambling code for despreading and integrating output signal& of a rake receiver; a soft limiter for performing soft decisions and generating a soft-limited signal; a weighting control unit cascaded to the soft limiter for controlling a slope of the soft limiter; a re-spreading unit for respreading the soft-limited signal outputted from the soft limiter based on a walsh code and a scrambling code, and generating a re-spread signal; an interference generator for computing MAI and IPI included in the signal received at the rake receiver; and an interference signal removing unit for removing the MAI and IPI from a signal received at the rake receiver.

In accordance with another aspect of the present invention, there is provided a multistage adaptive partial parallel interference canceller (PIC) in a downlink receiver having a plurality of channels, for removing multiple access interference (MAI) and interpath interference (IPI), including: a filter matched to a desired walsh code and a scrambling code for despreading and integrating output signal of a rake receiver; a soft limiter for performing soft decisions and generating a soft-limited signal; a weighting control unit cascaded to the soft limiter for controlling a slope of the soft limiter; a re-spreading unit for respreading the soft-limited signal outputted from the soft limiter based on a walsh code and a scrambling code, and generating a re-spread signal; an interference generator for computing MAI and IPI included in the output signal of the rake receiver; and an interference signal removing unit for removing the MAI and IPI from the output signal of the rake receiver.

In accordance with still another aspect of the present invention, there is provided a multistage adaptive partial parallel interference canceller (PIC) in an uplink receiver having a plurality of channels, for removing multiple access interference (MAI) and interpath interference (IPI), including: a filter matched to the desired walsh code and scrambling code for despreading and integrating an output signal of the rake receiver; a soft limiter for performing soft decisions and generating a soft-limited signal; a weighting control unit cascaded to the soft limiter for controlling a slope of the soft limiter; a re-spreading unit for respreading the soft-limited signal outputted from the soft limiter based on a walsh code and a scrambling code, and generating a re-spread signal; an interference generator for computing MAI and IPI included in the signal received at the output of rake receiver; and an interference signal removing unit for removing the MAI and IPI from a signal received at the rake receiver.

In accordance with still another aspect of the present invention, there is provided a multistage adaptive partial parallel interference canceller (PIC) in an uplink receiver having a plurality of channels, for removing multiple access interference (MAI) and interpath interference (IPI), including: a soft limiter for performing soft decisions and generating a soft-limited signal; a weighting control unit cascaded to the soft limiter for controlling the slope of the soft limiter; a re-spreading unit for respreading the soft-limited signal outputted from the soft limiter based on a walsh code and a scrambling code, and generating a re-spread signal; an interference generator for computing MAI and IPI included in the output signal of the matched filter; a filter matched to a desired walsh code and a scrambling code for despreading and integrating the output signals of a rake receiver; and an interference signal removing unit for removing the MAI and IPI from an output signal of the filter.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram showing a conventional is multistage parallel interference canceller (PIC) having hard limiters;

FIG. 2 is a block diagram showing an internal structure of an i^{th} interference canceller in FIG. 1;

FIG. 3 is a block diagram showing a multistage adaptive partial parallel interference canceller (PIC) for removing an interference signal at a downlink in accordance with a preferred embodiment of the present invention;

FIG. 4 is a diagram showing a simplified structure of a transmitting unit in accordance with the preferred embodiment of the present invention;

FIG. 5 is a block diagram showing a detailed structure of a receiving unit in accordance with the preferred embodiment of the present invention;

FIG. 6 is a block diagram showing a rake receiver in accordance with the preferred embodiment of the present invention;

FIG. 7 is a block diagram showing an i^{th} interference canceller in accordance with the present invention;

FIG. 8 is a block diagram showing a simplified i^{th} interference canceller in accordance with the present invention;

FIG. 9 is a block diagram showing an interference canceller having a feedback structure in accordance with the present invention;

FIG. 10 is a block diagram showing a multistage adaptive partial PIC for removing an interference signal at an uplink in accordance with the preferred embodiment of the present invention;

FIG. 11 is a block diagram showing a simplified structure of a transmitting unit shown in FIG. 10 in accordance with the preferred embodiment of the present invention;

FIG. 12 is a block diagram showing a detailed structure of a receiving unit in accordance with the preferred embodiment of the present invention;

FIG. 13 is a block diagram showing a rake receiver shown in FIG. 12 in accordance with the preferred embodiment of the present invention;

FIG. 14 is a block diagram showing an i^{th} interference canceller shown in FIG. 12 in accordance with the present invention;

FIG. 15 is a block diagram showing an interference canceller having a feedback structure in accordance with the present invention;

FIG. 16 is a block diagram showing a multistage adaptive partial PIC in accordance with another embodiment of the present invention;

FIG. 17 is a block diagram showing an interference canceller having a feedback structure in accordance with the present invention;

FIG. 18 is a graph showing performance of the conventional PIC and the existing multistage adaptive partial PICs with the multistage adaptive partial PIC of the present invention;

FIG. 19A is a graph showing a performance of an existing multistage partial PIC having soft limiters cascaded to weighting units; and

FIG. 19B is a graph showing a performance of an adaptive multistage partial PIC in accordance with the present invention.

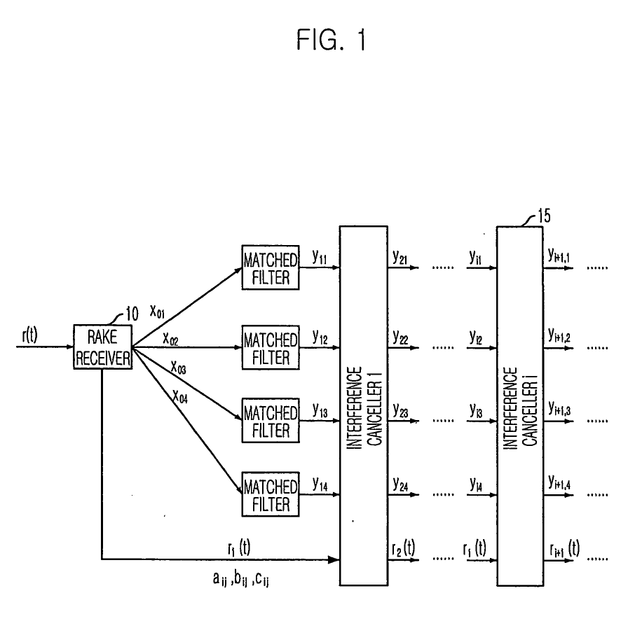

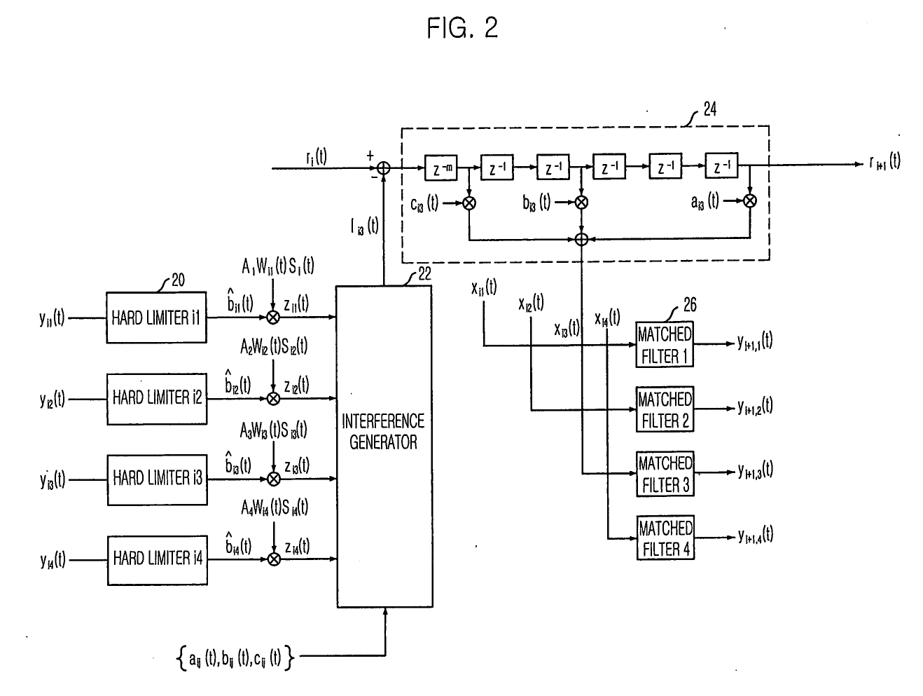

### BEST MODE FOR CARRYING OUT THE INVENTION

Other objects and aspects of the invention will become apparent from the following description of the embodiments with reference to the accompanying drawings, which is set forth hereinafter.

A preferred embodiment of the present invention is explained in details by dividing the embodiment into a downlink and an uplink. Hereinafter, i denotes an i^{th} interference canceller and j denotes a j^{th} channel in order to describe a certain signal as Xᵢⱼ.

<Downlink>

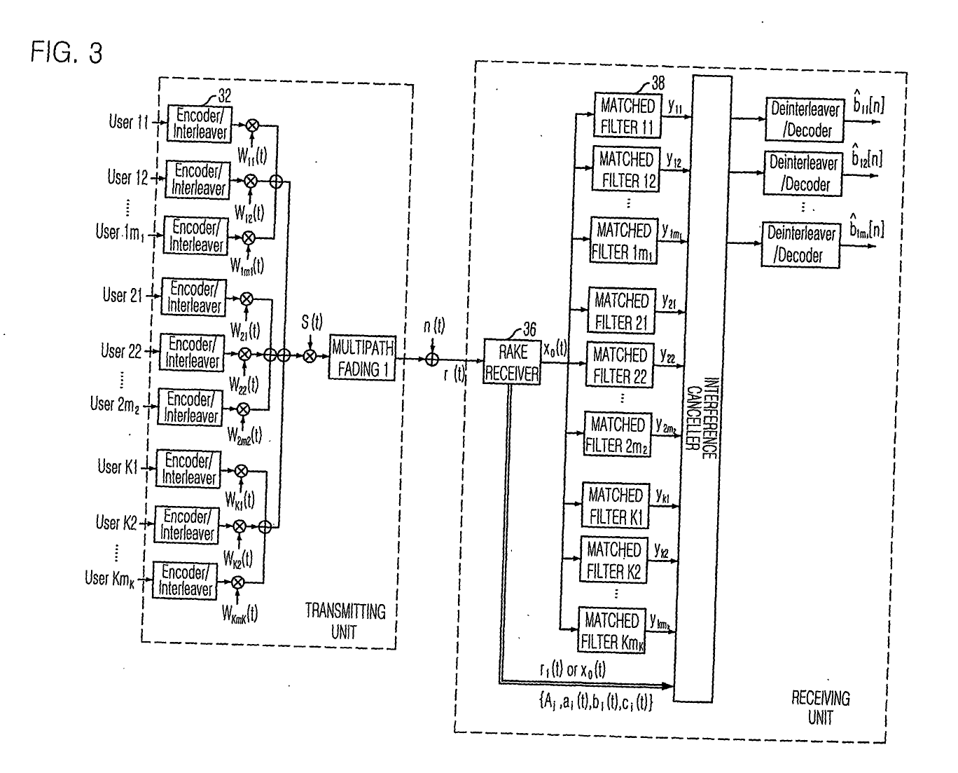

FIG. 3 is a block diagram showing a multistage adaptive partial parallel interference canceller (PIC) for removing an interference signal at a downlink in accordance with a preferred embodiment of the present invention.

Referring to FIG. 3, K users are using their terminals and each terminal has mₖ channels having different data rates. Data of each channel to be transmitted by the a base station are encoded and interleaved by an encoder/interleaver 32, and multiplied by a Walsh code Wₖ(t) to separate different channels.

Then, the output signals from different channels are summed and a scrambling code S(t) is multiplied to the summed signal in order to identify the base station. Each signal is transmitted over multipath fading channel and a rake receiver 36 receives the signal contaminated by white Gaussian noise n(t).

Received radio frequency (RF) signals may have different amplitudes or phases resulted from reflection or diffraction made by irregular terrains and obstacles. It is called the multi-path fading. The rake receiver 36 combines the multipath signals and maximizes the signal to noise ratio.

An output signal from the rake receiver 36 is inputted to a matched filter 38 and a signal component yᵢⱼ for each channel is outputted from the matched filter 38. However, the signal component yᵢⱼ contains multiple access interference (MAI) and inter-path interference (IPI) are contained in the signal component yᵢⱼ and the signal component yᵢⱼ is time varying. The multistage adaptive partial PIC of the present invention coupled to the rake receiver 36 is to efficiently remove MAI and IPI.

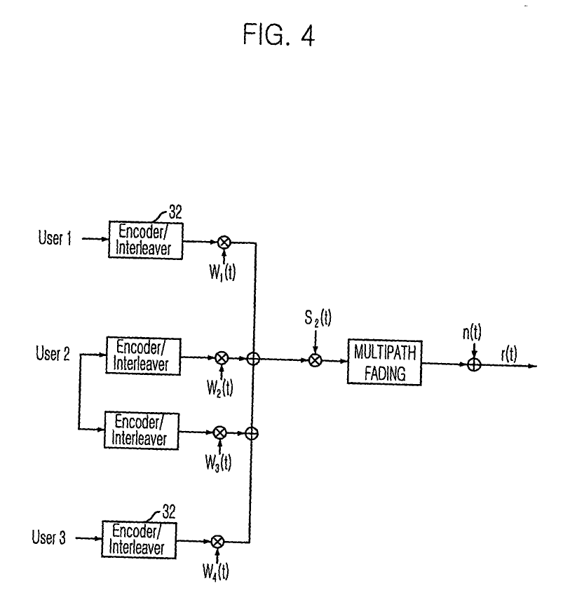

FIG. 4 is a block diagram showing a simplified structure of a transmitting unit shown in FIG. 3 in accordance with the preferred embodiment of the present invention. The transmitting unit represents a part of base station which transmits a signal to a user terminal.

Referring to FIG. 4, it is assumed that each of three users uses one channel or two channels having various data rates. The user can separately transmit voice signals and video signals through two channels.

As mention with reference to FIG. 3, the signal outputted from the encoder/interleaver 32 is multiplied by the walsh code Wⱼ(t) in order to separate channels. Then, the scrambling code S(t) is multiplied to the signal in order to identify the base stations and the signal is transmitted to the user terminal over multipath fading channel. The received signal is contaminated by the white noise n(t).

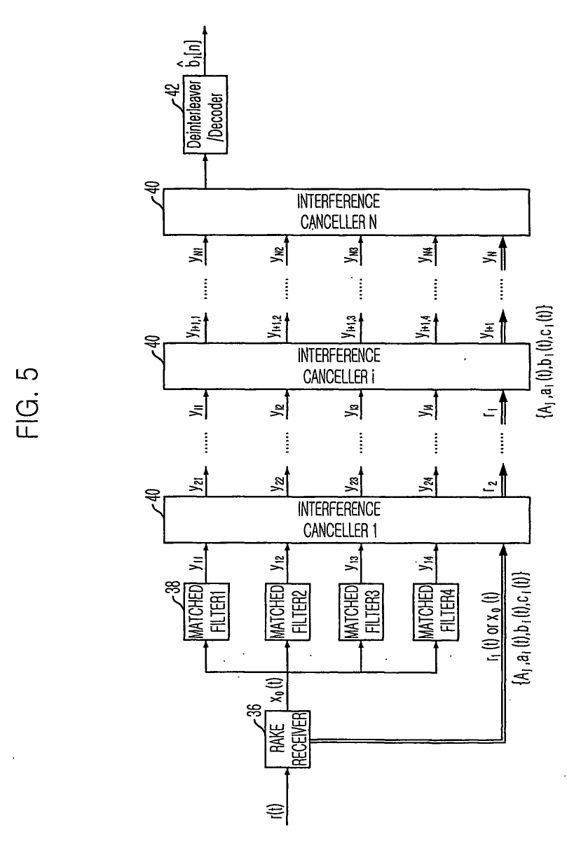

FIG. 5 is a block diagram showing a detailed structure of a receiving unit shown in FIG. 3 in accordance with the preferred embodiment of the present invention. The receiving unit represents a part of mobile terminal which receives a signal from a base station.

Referring to FIG. 5, the rake receiver 36 receives a signal transmitted over multipath fading channel and contaminated by white Gaussian noise. The rake receiver 36 combines the multipath signals and maximizes the signal to noise ratio with path gains obtained from the outputs of channel estimator and the signal x₀(t) is a normalized signal with squared sum of estimated multipath gains The signal x₀(t) is inputted to the matched filter 38 of each channel and an output signal Y₁ⱼ of the matched filter, for j=1 to 4, is generated. The signal components Y₁ⱼ are inputted to a first interference canceller 40 and the first interference canceller 40 outputs signals to the second interference canceller 40. The signals are subsequently inputted to a next interference cancellers 40 in this manner.

The interference signals are precisely computed and removed from the received signal by the multistage PIC 40. Fianlly, the more reliable information bits of each user can be obtained with a deinterleaver/decoder 42.

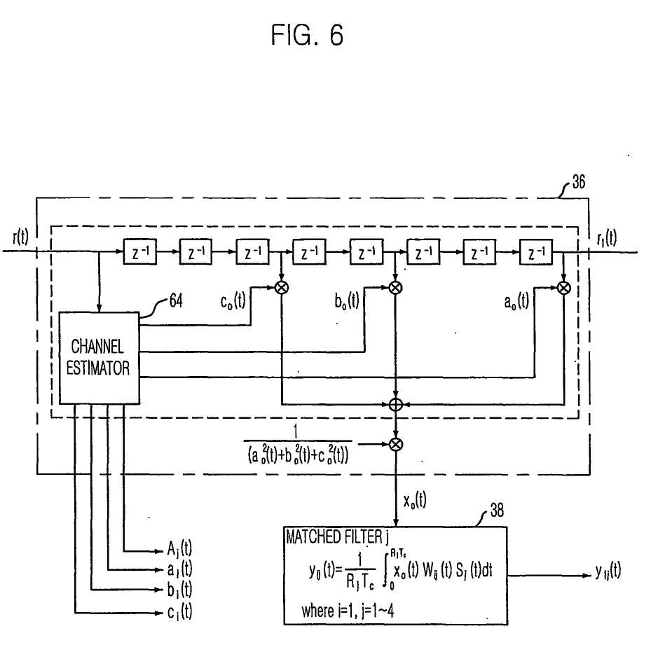

FIG. 6 is a block diagram showing a rake receiver shown in FIG. 5 in accordance with the preferred embodiment of the present invention.

Referring to FIG. 6, the rake receiver 36 of the user terminal receives a signal r(t) transmitted from the base station. The channel estimator 64 in the rake receiver 36 outputs tap gains aᵢ(t), bᵢ(t) and cᵢ(t) of each finger and estimated signal strength Aⱼ(t) of each channel.

If the time delayed signals are received through multi-path, the received signals are multiplied by the tap gains of the channel estimator 64, summed and inputted to the matched filter 38. In order to prevent orthogonality of the signals from being damaged on the time varying channel, a normalization of the output signals from the rake receiver is suggested in the present invention. That is, the output signals of the conventional rake receiver, i.e., dashed block in FIG. 6, are divided by a sum of squared tap gains.

A normalized signal x₀ of the rake receiver 36 is inputted to the matched filter 38. An operation of the matched filter is described as an equation shown in the matched filter block 38 of FIG. 6. That is, the output signal x₀(t) is multiplied by the walsh code Wᵢⱼ(t) which separates user channels and the scrambling code Sᵢ(t) which identifies the base station, and integrated for RⱼT_{c}. Herein, an Rⱼ is a spreading gain of a j^{th} channel and 1/T_{c} is a chip rate.

An output signal y₁ⱼ(t) of the matched filter 38 is inputted to the first interference canceller 40 and a precise interference signal is computed by the multistage interference canceller 40.

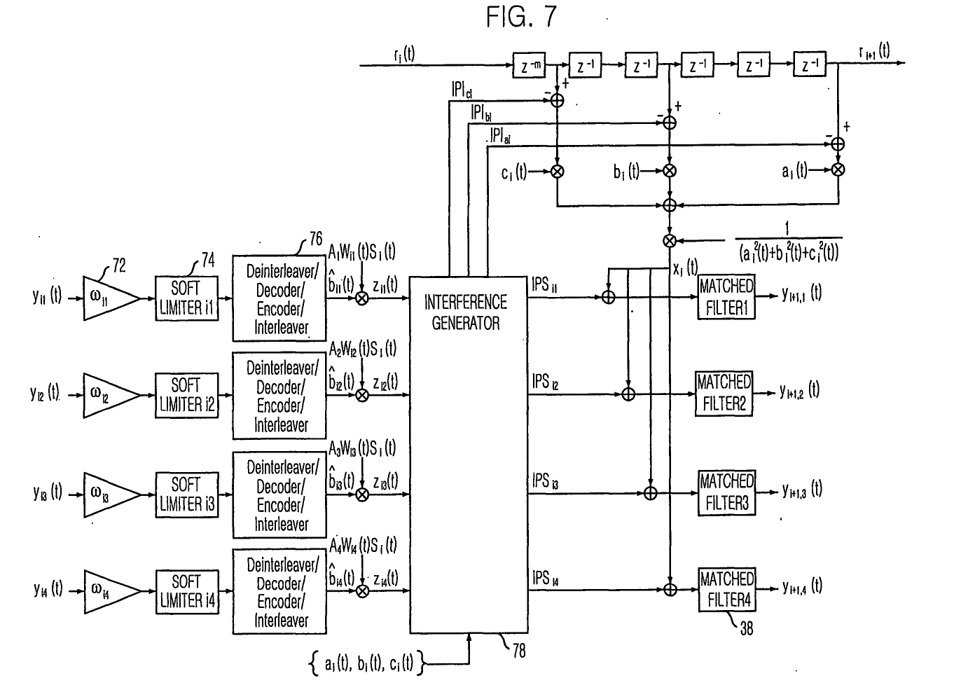

FIG. 7 is a block diagram showing an i^{th} interference canceller shown in FIG. 5 in accordance with the present invention.

The multistage adaptive parallel PIC of the present invention includes a soft limiter and a weighting controller. A slope of the soft limiter is controlled by the weighting controller.

It is preferred that a slope-controllable hyperbolic tangent function is used as a characteristic of the soft limiter and an optimization of the slope control can be simply done by updating the weighting unit cascaded to the soft limiter. The slope of the hyperbolic tangent function at each stage is adjusted to be monotonically increased from the first stage to the last stage. Performance degradation at various channels is prevented by separately controlling the slope of each soft limiter according to channel environments of users.

Referring to FIG. 7, the slope of the soft limiter is optimized by controlling a weight ω with the weighting controller 72 cascaded to the soft limiter whose characteristic is hyperbolic tangent and slope equals to be 1. The hyperbolic tangent function is expressed as:

$$tanh ( ω U ) = \frac{{ⅇ}^{ω U} - {ⅇ}^{ω U}}{{ⅇ}^{ω U} + {ⅇ}^{ω U}} \qquad Eq . 2$$

The weighting controller 72 controls the slope of the soft limiter 74 with LMS algorithm or an average to variance ratio estimation algorithm.

The LMS algorithm is described as:

For i=1 to N and j=1 to 4
ωᵢⱼ(n+1)=ωᵢⱼ(n)+η(\hat{b}ⱼ(n)−\hat{b}ᵢⱼ(n))(1−\hat{b}ᵢⱼ(n))(1+\hat{b}ᵢⱼ(n))+β(ωᵢⱼ(n)−ωᵢⱼ(n−1)) Eq. 3

where η and β denote learning rate and momentum factor

The average to variance ratio estimation algorithm is expressed as:

$$\begin{matrix}\begin{matrix}\begin{matrix}\begin{matrix} F or i = 1 to N and i = 1 to 4 \\ {\overline{A}}_{ij} ( n ) = ( 1 - {α}_{ij} ( n ) ) {\sum }_{l = 0}^{n} {α}_{ij}^{n - 1} ( l ) {y}_{ij} ( l ) {\hat{b}}_{j} ( l ) \end{matrix} \\ {\overline{σ}}_{ij}^{2} ( n ) = ( 1 - {α}_{ij} ( n ) ) {\sum }_{l = 0}^{n} {α}_{ij}^{n - 1} ( l ) {( {y}_{ij} ( l ) - {\overline{A}}_{ij} ( l ) {\hat{b}}_{j} ( l ) )}^{2}\end{matrix} \\ {α}_{ij} ( n + 1 ) = \{ \begin{matrix}0 & for n = - 1 \\ t & where t is aproximately 1 but less than 1 , \\ & when {( \frac{γ {\overline{A}}_{ij} ( n )}{κ {\overline{σ}}_{ij} ( n )} )}^{2} = 0 , and n \geq 0 \\ 1 - {( \frac{γ {\overline{A}}_{ij} ( n )}{κ {\overline{σ}}_{ij} ( n )} )}^{2} & when 0 ≺ {( \frac{γ {\overline{A}}_{ij} ( n )}{κ {\overline{σ}}_{ij} ( n )} )}^{2} ≺ 1 , and n \geq 0 \\ 0 & when {( \frac{γ {\overline{A}}_{ij} ( n )}{κ {\overline{σ}}_{ij} ( n )} )}^{2} \geq 1 , and n \geq 0\end{matrix}\end{matrix} \\ where γ is a accuracy control factor of mean estimation \\ for controlling κ {\overline{σ}}_{ij} ( n ) to be less than γ {\overline{A}}_{ij} ( n ) , and \\ κ is a confidentional interval control factor \\ representing the true mean A ( n ) is in the range of \\ {\overline{A}}_{ij} ( n ) - {κσ}_{ij} ( n ) ≺ A ( n ) ≺ {\overline{A}}_{ij} ( n ) + κ {\overline{σ}}_{ij} ( n ) , \\ {ω}_{ij} ( n + 1 ) = \frac{{\overline{A}}_{ij} ( n )}{{\overline{σ}}_{ij}^{2} ( n )} \\ Π ( \frac{t}{T} ) ≡ \{ \begin{matrix}1 & for - 1 / 2 T π t \leq - 1 / 2 T \\ 0 & otherwise \end{matrix}\end{matrix} \qquad Eq . 4$$

If an output signal yᵢⱼ(t) of the i−1^{th} interference canceller is inputted to the i^{th} interference canceller, a magnitude of the j^{th} channel is determined by the soft limiter 74 having a slope controlled by the weighting controller 72. That is, the magnitude of the output signal has a soft value according to the controlled slope instead of being determined as +1 or 31 1.

A signal outputted from the soft limiter 74 subsequently experiences a deinterleaving, a decoding and an encoding. Then, the signal is respread by the walsh code Wᵢⱼ(t) and the scrambling code Sᵢ(t). The spread signal is inputted to an interference generator 78 and an interference signal included in each channel is computed.

The interference signal computed by the interference generator 78 is expressed as:

$$\begin{matrix}\begin{matrix}\begin{matrix}\begin{matrix}\begin{matrix}\begin{matrix}For i = 1 to N and j = 1 to 4 \\ {z}_{i} ( t ) = {\sum }_{j = 1}^{4} {z}_{ij} ( t ) {IPI}_{ai} ( t ) = {\overline{b}}_{i} ( t - 3 {T}_{c} ) {z}_{i} ( t - 3 {T}_{c} ) + {\overline{c}}_{i} ( t - 5 {T}_{c} ) {z}_{i} ( t - 5 {T}_{c} )\end{matrix} \\ {IPI}_{bi} ( t ) = {\overline{a}}_{i} ( t + 3 {T}_{c} ) {z}_{i} ( t + 3 {T}_{c} ) + {\overline{c}}_{i} ( t - 2 {T}_{c} ) {z}_{i} ( t - 2 {T}_{c} )\end{matrix} \\ {IPI}_{ci} ( t ) = {\overline{a}}_{i} ( t + 5 {T}_{c} ) {z}_{i} ( t + 5 {T}_{c} ) + {\overline{b}}_{i} ( t + 2 {T}_{c} ) {z}_{i} ( t + 2 {T}_{c} )\end{matrix} \\ \begin{matrix}{IPS}_{ij}^{′} ( t ) = Π ( \frac{t - ( {R}_{j} + 3 ) {T}_{c} / 2}{( {R}_{j} - 3 ) {T}_{c}} ) {\overline{b}}_{i} ( t - 3 {T}_{c} ) {z}_{ij} ( t - 3 {T}_{c} ) + \\ Π ( \frac{t - ( {R}_{j} + 5 ) {T}_{c} / 2}{( {R}_{j} - 5 ) {T}_{c}} ) {\overline{c}}_{i} ( t - 5 {T}_{c} ) {z}_{ij} ( t - 5 {T}_{c} ) + \\ Π ( \frac{t - ( {R}_{j} - 3 ) {T}_{c} / 2}{( {R}_{j} - 3 ) {T}_{c}} ) {\overline{a}}_{i} ( t + 3 {T}_{c} ) {z}_{ij} ( t + 3 {T}_{c} ) + \\ Π ( \frac{t - ( {R}_{j} + 2 ) {T}_{c} / 2}{( {R}_{j} - 2 ) {T}_{c}} ) {\overline{c}}_{i} ( t - 2 {T}_{c} ) {z}_{ij} ( t - 2 {T}_{c} ) + \\ Π ( \frac{t - ( {R}_{j} - 5 ) {T}_{c} / 2}{( {R}_{j} - 5 ) {T}_{c}} ) {\overline{a}}_{i} ( t + 5 {T}_{c} ) {z}_{ij} ( t + 5 {T}_{c} ) + \\ Π ( \frac{t - ( {R}_{j} - 2 ) {T}_{c} / 2}{( {R}_{j} - 2 ) {T}_{c}} ) {\overline{b}}_{i} ( t + 2 {T}_{c} ) {z}_{ij} ( t + 2 {T}_{c} ) ,\end{matrix}\end{matrix} \\ {IPS}_{ij} ( t ) - {IPS}_{ij}^{′} ( t ) / {B}_{i} ( t )\end{matrix} \\ where {B}_{i} ( t ) = {\overline{a}}_{i}^{2} ( t ) + {\overline{b}}_{i}^{2} ( t ) + {\overline{c}}_{i}^{2} ( t )\end{matrix} \qquad Eq . 5$$

The computed interference signals with Eq. 5 are removed from the output signals of each finger of the rake receiver and the interference-removed signals are normalized by the tap gains of the rake receiver. Then, normalized signals xᵢ(t) are outputted from the rake receiver.

The signals rᵢ(t), aᵢ(t), bᵢ(t), cᵢ(t) are time delayed signals of r(t), a₀(t), b₀(t), c₀(t) according to a processing delay upto the i^{th} interference canceller.

IPSᵢⱼ computed with Eq. 5 is summed with the normalized signals xᵢ(t) outputted from the rake receiver to compensate over-removed signals.

As mentioned above, the interference signals are removed at the i^{th} interference canceller and the interference subtracted signals are passed to the filter matched to the desired walsh code and scrambling code. Then, the output signals of the matched filter are passed to the i+1^{th} interference canceller.

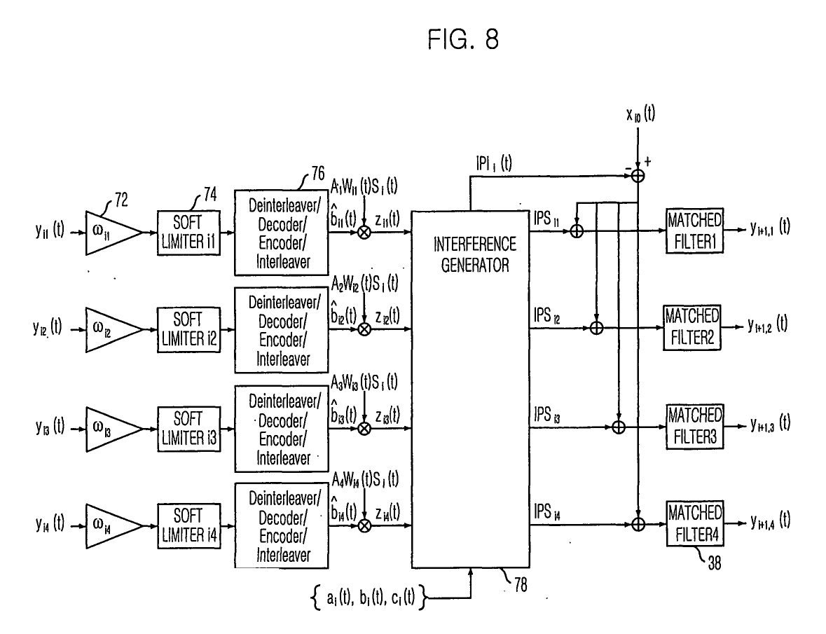

FIG. 8 is a block diagram showing the i^{th} interference canceller simplified by modifying the computation used in the interference canceller of FIG. 7 in accordance with the present invention. The same reference numbers used in FIG. 7 are used in FIG. 8 because functions of the units are the same.

The modified computation method is expressed as:

$$\begin{matrix}\begin{matrix}\begin{matrix}\begin{matrix}\begin{matrix}\begin{matrix}\begin{matrix}\begin{matrix}\begin{matrix}\begin{matrix}\begin{matrix}For i = 1 to N and j = 1 to 4 Eq . 6 \\ {z}_{i} ( t ) = {\sum }_{j = 1}^{4} {z}_{ij} ( t ) \end{matrix} \\ \begin{matrix}{IPI}_{i}^{′} ( t ) = {\overline{a}}_{i} ( t ) ( {\overline{b}}_{i} ( t - 3 {T}_{c} ) {z}_{i} ( t - 3 {T}_{c} ) + {\overline{c}}_{i} ( t - 5 {T}_{c} ) {z}_{i} ( t - 5 {T}_{c} ) ) + \\ {\overline{b}}_{i} ( t ) ( {\overline{a}}_{i} ( t + 3 {T}_{c} ) {z}_{i} ( t + 3 {T}_{c} ) + {\overline{c}}_{i} ( t - 2 {T}_{c} ) {z}_{i} ( t - 2 {T}_{c} ) ) + \\ {\overline{c}}_{i} ( t ) ( {\overline{a}}_{i} ( t + 5 {T}_{c} ) {z}_{i} ( t + 5 {T}_{c} ) + {\overline{b}}_{i} ( t + 2 {T}_{c} ) {z}_{i} ( t + 2 {T}_{c} ) )\end{matrix}\end{matrix} \\ {IPS}_{ij}^{′} ( t ) = Π ( \frac{t - ( {R}_{j} + 3 ) {T}_{c} / 2}{( {R}_{j} - 3 ) {T}_{c}} ) \overline{{a}_{i}} ( t ) \overline{{b}_{i}} ( t - 3 {T}_{c} ) {z}_{ij} ( t - 3 {T}_{c} ) +\end{matrix} \\ Π ( \frac{t - ( {R}_{j} + 5 ) {T}_{c} / 2}{( {R}_{j} - 5 ) {T}_{c}} ) \overline{{a}_{i}} ( t ) \overline{{c}_{i}} ( t - 5 {T}_{c} ) {z}_{ij} ( t - 5 {T}_{c} ) +\end{matrix} \\ Π ( \frac{t - ( {R}_{j} - 3 ) {T}_{c} / 2}{( {R}_{j} - 3 ) {T}_{c}} ) \overline{{b}_{i}} ( t ) \overline{{a}_{i}} ( t + 3 {T}_{c} ) {z}_{ij} ( t + 3 {T}_{c} ) +\end{matrix} \\ Π ( \frac{t - ( {R}_{j} + 2 ) {T}_{c} / 2}{( {R}_{j} - 2 ) {T}_{c}} ) \overline{{b}_{i}} ( t ) \overline{{c}_{i}} ( t - 2 {T}_{c} ) {z}_{ij} ( t - 2 {T}_{c} ) +\end{matrix} \\ Π ( \frac{t - ( {R}_{j} - 5 ) {T}_{c} / 2}{( {R}_{j} - 5 ) {T}_{c}} ) \overline{{c}_{i}} ( t ) \overline{{a}_{i}} ( t + 5 {T}_{c} ) {z}_{ij} ( t + 5 {T}_{c} ) +\end{matrix} \\ Π ( \frac{t - ( {R}_{j} - 2 ) {T}_{c} / 2}{( {R}_{j} - 2 ) {T}_{c}} ) \overline{{c}_{i}} ( t ) \overline{{b}_{i}} ( t + 2 {T}_{c} ) {z}_{ij} ( t + 2 {T}_{c} )\end{matrix} \\ {IPS}_{ij} ( t ) = {IPS}_{ij}^{′} ( t ) / {B}_{i} ( t )\end{matrix} \\ where {B}_{i} ( t ) = {\overline{a}}_{i}^{2} ( t ) + {\overline{b}}_{i}^{2} ( t ) + {\overline{c}}_{i}^{2} ( t )\end{matrix} \\ {IPI}_{i} ( t ) = {IPI}_{i}^{′} ( t ) / {B}_{i} ( t )\end{matrix}$$

The interference signals computed by the interference generator 78 are removed at the signal xᵢ₀ instead of being removed at each finger. The signal xᵢ₀ is time shifted as much as the processing delay of the i^{th} interference canceller.

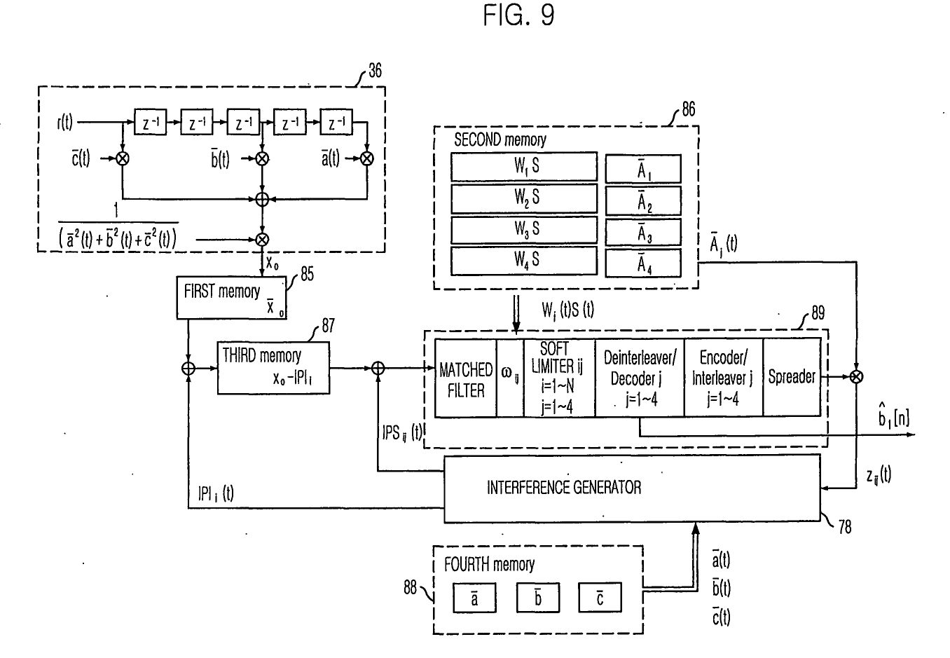

FIG. 9 is a block diagram showing an i^{th} interference canceller having a feedback structure in accordance with the present invention. Because a plurality of interference cancellers repeat the same function at each stage, the multistage adaptive partial PIC can be implemented in a simple structure by storing the output signal of the rake receiver and using the stored signal repeatedly.

Referring to FIG. 9, the signal x₀ outputted from the rake receiver is stored in the first memory 85. The second memory 86 stores the walsh code Wⱼ of each channel, the scrambling code S and the magnitudes Aⱼ of signal received at each channel.

The interference signals IPIᵢ computed by the interference generator 84 are removed from the signal x₀ outputted from the rake receiver and the interference-removed signal is stored in the third memory 87. Also, the forth memory 88 stores the tap gains a, b and c outputted from the channel estimator.

A signal processing unit 89 could be a device packaged by an application specific integrated circuit (ASIC) or a digital signal processor (DSP). The signal processing unit 89 includes a matched filter, a weighting controller, a soft limiter, a deinterleaver/decoder, an encoder/interleaver and a spreader, and executes each function subsequently.

An operation process of the interference canceller of FIG. 9 is the same as that of FIG. 8. That is, the interference signals IPIᵢ computed by the interference generator 84 are removed from the signal x₀ outputted from the rake receiver and the interference-removed signal is stored in the third memory 87. The signal stored in the third memory 87 is compensated by the IPSᵢⱼ and inputted to the signal processing unit 89. Herein, the IPSᵢⱼ computed by the Eq. 6 compensates the over-removed signal.

The signal processing unit 89 executes the functions of the matched filter, the weighting controller, the soft limiter, the deinterleaver/decoder, the encoder/interleaver and the spreader, and outputs the signal to the interference generator 78. Herein, the spreader of the signal processing unit 89 re-spreads the received signal by using the Walsh code Wⱼ of each channel, the scrambling code S and the magnitudes Aⱼ of a received signal at each channel that are stored in the second memory 36.

The interference generator 78 more precisely computes the interference signals by using the re-spread signal and the tap gains stored in the fourth memory 88. The computed interference signals are removed from the signal x₀ outputted from the rake receiver 36 and the interference-removed signal is stored in the first memory 85. As the feedback is repeated, the more precise interference signals are computed. If the interference signals are converged, the converged interference signals are removed from the signal outputted from the rake receiver and the desired user's signal is extracted.

Therefore, the disadvantage of the nonlinear MUD is overcome by using the feedback structure and the circuit complexity can be drastically reduced.

<Uplink>

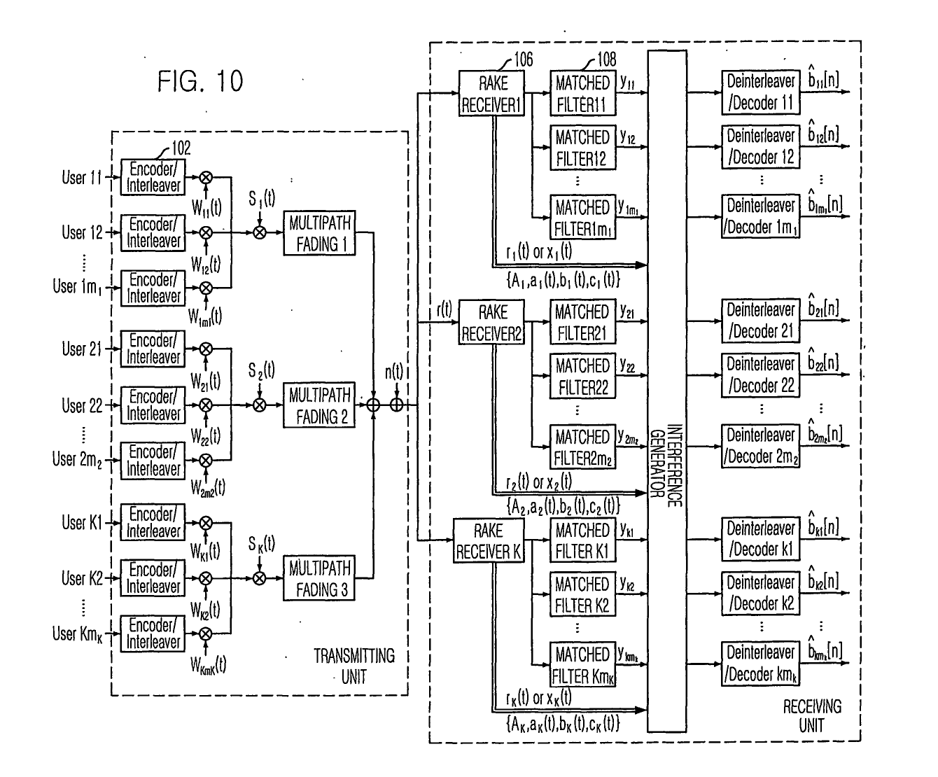

FIG. 10 is a block diagram showing a multistage adaptive partial PIC for removing an interference signal at an uplink in accordance with the preferred embodiment of the present invention.

Referring to FIG. 10, K users are using their terminals and each terminal has mₖ channels having different data rates. Data of each channel to be transmitted by a mobile terminal are encoded and interleaved by an encoder/interleaver 102, and multiplied by a Walsh code Wₖ(t).

Then, the output signals of channels are summed and a scrambling code Sⱼ(t) is multiplied to the summed signal in order to identify the mobile terminal. Each signal is transmitted over multipath fading channel and a rake receiver 106 receives the signal contaminated by white Gaussian noise n(t).

An output signal from the rake receiver 106 is inputted to a matched filter 108 and a signal components yᵢⱼ for each channel is outputted from the matched filter 108. However, the signal component yᵢⱼ that contains multiple access interference (MAI) and inter-path interference (IPI) is time varying. Therefore, the multistage adaptive partial PIC of the present invention coupled to rake receiver is to efficiently remove MAI and IPI.

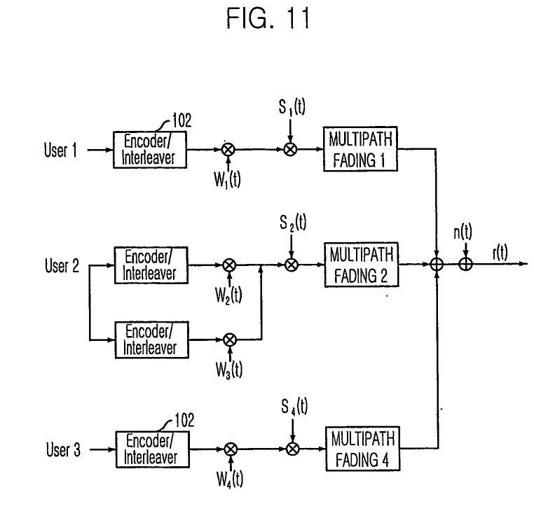

FIG. 11 is a block diagram showing a simplified structure of a transmitting unit shown in FIG. 10 in accordance with the preferred embodiment of the present invention. The transmitting unit represents a part of mobile-terminal which transmits a signal to a base station.

Referring to FIG. 11, it is assumed that each of three users uses one channel or two channels having various data rates. The user can separately transmit voice signals and video signals through two channels.

As mentioned with reference to FIG. 10, the signal outputted from the encoder/interleaver 102 is multiplied with the walsh code Wⱼ(t) in order to separate channels. Then, the scrambling code Sⱼ(t) is multiplied to the signal in order to identify the mobile terminal and the signal is transmitted to the base station over multipath fading channel. The received signal is contaminated by the white noise n(t).

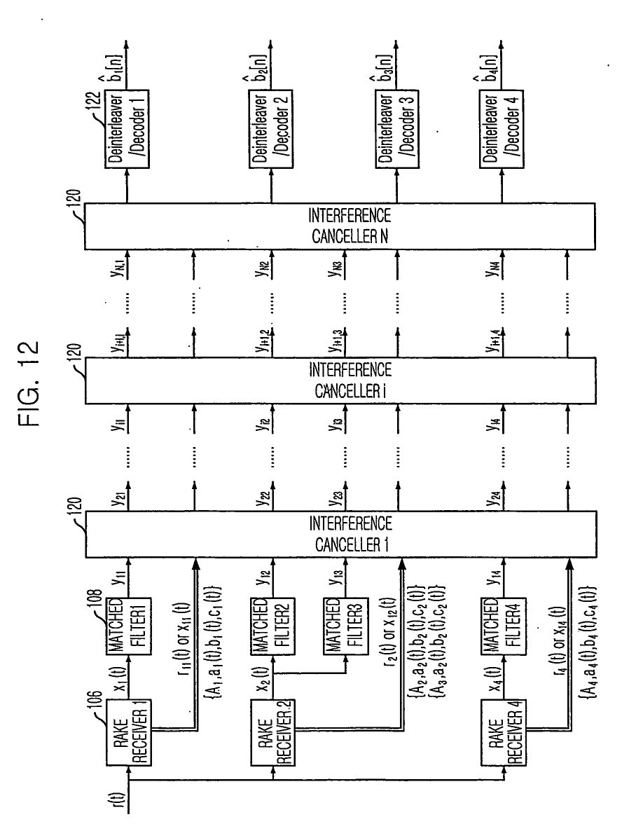

FIG. 12 is a block diagram showing a detailed structure of a receiving unit shown in FIG. 10 in accordance with the preferred embodiment of the present invention. The receiving unit represents a part of base station which receives a signal from mobile terminals.

Referring to FIG. 12, the rake receiver 106 receives a signal transmitted over multipath fading channel and contaminated by white Gaussian noise. The rake receiver 106 combines the multipath signals and maximizes the signal to noise ratio with path gains obtained from the outputs of channel estimator and the signal xⱼ(t) is a normalized signal with squared sum of estimated multipath gains. The signal xⱼ(t) is inputted to the matched filter 108 of each channel and its output signal y₁ⱼ, for j=1-4, is generated. The signals y₁ⱼ are inputted to the first interference canceller 120 and output signals from the first interference canceller 120 are inputted to the second interference canceller 120. The signals are subsequently inputted to next interference cancellers in this manner.

The interference signals are precisely computed and removed from the received signal of each channel by the multistage interference canceller 120. Then, more reliable information bits of each user can be obtained with a deinterleaver/decoder 122.

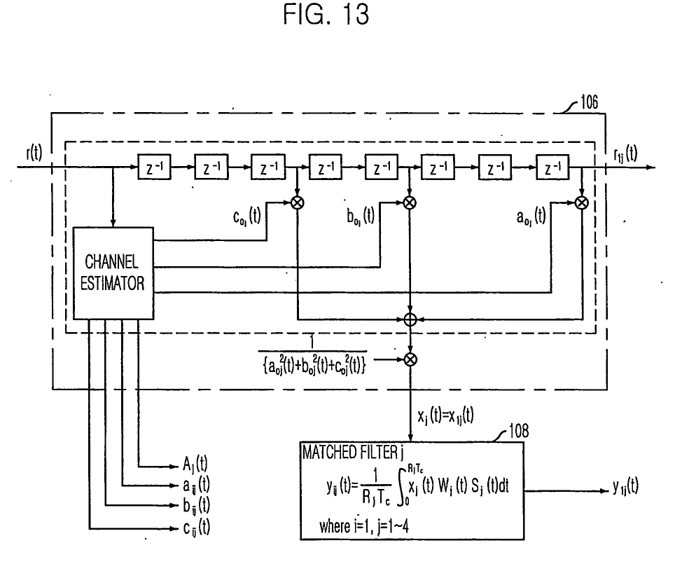

FIG. 13 is a block diagram showing a rake receiver shown in FIG. 12 in accordance with the preferred embodiment of the present invention.

Referring to FIG. 13, the rake receiver 106 of the base station receives a signal r(t) transmitted from the mobile terminal. The channel estimator 134 in the rake receiver 106 outputs tap gains aᵢⱼ(t), bᵢⱼ(t) and cᵢⱼ(t) of each finger and estimated signal strength Aⱼ(t) of each channel

If the time delayed signals are received through multi-path, the received signals are multiplied by the tap gains of the channel estimator 134, summed and inputted to the matched filter 108. In order to prevent orthogonality of the signals from damaged on the time varying channel, a normalization of the output signals from the rake receiver is suggested in the present invention. That is, the output signals of the conventional rake receiver, i.e., dashed block in FIG. 13, are divided by a sum of squared tap gains.

A normalized signal xⱼ of the rake receiver 106 is inputted to the matched filter 108. A matching operation of the matched filter xⱼ is described as an equation in the matched filter block 108 of FIG. 13. That is, the output signal xⱼ(t) is multiplied by the walsh code Wⱼ(t) which separates user channels and the scrambling code Sⱼ(t) which identifies the mobile terminal, and integrated for RⱼT_{c}. Herein, an Rⱼ is a spreading gain of a j^{th} channel and 1/T_{c} is a chip rate.

An output signal y₁ⱼ(t) of the first matched filter 108 is inputted to the first interference canceller 120 and a precise interference signal is computed by the multistage interference canceller 120.

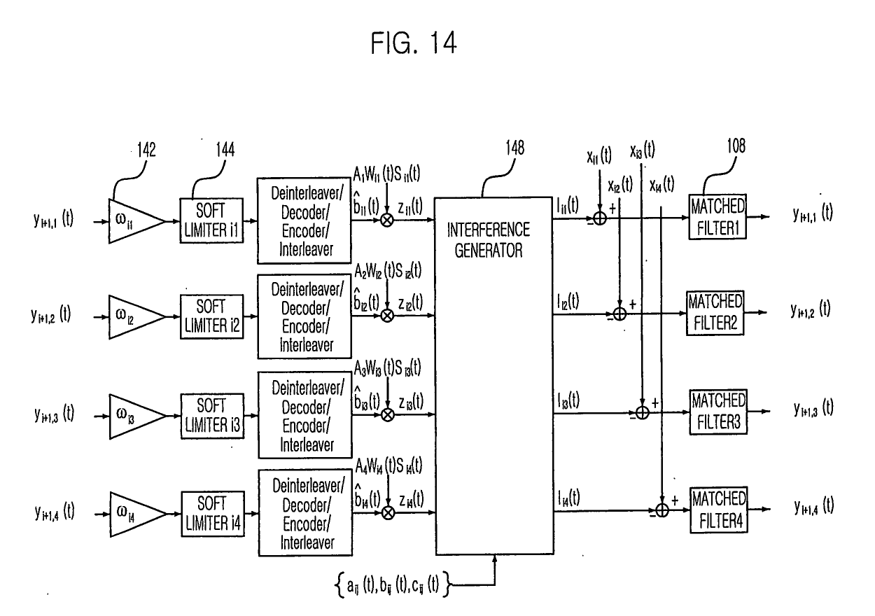

FIG. 14 is a block diagram showing the i^{th} interference canceller shown in FIG. 12 in accordance with the present invention.

The multistage adaptive parallel PIC of the present invention includes a soft limiter and a weighting controller. A slope of the soft limiter is controlled by the weighting controller.

It is preferred that a slope-controllable hyperbolic tangent function is used as a characteristic of the soft limiter and an optimization of the slope control can be simply done by updating the weighting unit cascaded to the soft limiter. The slope of the hyperbolic tangent function at each stage is adjusted to be monotonically increased from the first stage to the last stage. Performance degradation at various channels is prevented by separately controlling the slope of each soft limiter according to channel environments of users.

Referring to FIG. 14, the slope of the soft limiter is optimized by controlling a weight ω at the weighting controller 142 cascaded to the soft limiter whose characteristic is hyperbolic tangent of Eq. 2 and slope equals to be 1.

The weighting controller 142 controls the slope of the soft limiter 144 with LMS algorithm or average to variance ratio estimation algorithm.

The LMS algorithm and the average to variance ratio estimation algorithm are the same as the ones described in the downlink.

If an output signal yᵢⱼ(t) of the i−1^{th} interference canceller is inputted to the i^{th} interference canceller, a magnitude of the j^{th} channel is determined by the soft limiter 144 having a slope controlled by the weighting controller 142. That is, the magnitude of the output signal has a soft value according to the controlled slope instead of being determined as +1 or −1.

A signal outputted from the soft limiter 144 subsequently experiences a deinterleaving, a decoding and an encoding. Then, the signal is respread by the walsh code Wᵢⱼ(t) and the scrambling code Sᵢⱼ(t). The spread signal is inputted to an interference generator 148 and an interference signal included in each channel is computed.

The interference signal computed by the interference generator 148 is expressed as:

$$\begin{matrix}\begin{matrix}\begin{matrix}\begin{matrix}\begin{matrix}\begin{matrix}\begin{matrix}\begin{matrix}\begin{matrix}\begin{matrix}For j = 1 to 4 and i = 1 to N \\ {z}_{oij} ( t ) = ( {\overline{a}}_{ij} ( t ) {z}_{ij} ( t ) + {\overline{b}}_{ij} ( t - 3 {T}_{c} ) {z}_{ij} ( t - 3 {T}_{c} ) + {\overline{c}}_{ij} ( t - 5 {T}_{c} )\end{matrix} \\ {z}_{ij} ( t - 5 {T}_{c} ) )\end{matrix} \\ {MAI}_{oij} ( t ) = {\sum }_{{l = 1}_{l \neq j}}^{4} {z}_{oij} ( t )\end{matrix} \\ {MAI}_{ij} ( t ) = ( {\overline{a}}_{ij} ( t ) {MAI}_{oij} ( t ) + {\overline{b}}_{ij} ( t ) {MAI}_{oij} ( t + 3 {T}_{c} ) +\end{matrix} \\ {\overline{c}}_{ij} ( t ) {MAI}_{oij} ( t + 5 T ) )\end{matrix} \\ {IPI}_{ij} ( t ) = Π ( \frac{t - 3 / 2 {T}_{c}}{3 {T}_{c}} ) {\overline{a}}_{ij} ( t ) {\overline{b}}_{ij} ( t - 3 {T}_{c} ) {z}_{ij} ( t - 3 {T}_{c} ) +\end{matrix} \\ Π ( \frac{t - 5 / 2 {T}_{c}}{5 {T}_{c}} ) {\overline{a}}_{ij} ( t ) {\overline{c}}_{ij} ( t - 5 {T}_{c} ) {z}_{ij} ( t - 5 {T}_{c} ) +\end{matrix} \\ Π ( \frac{t - ( {R}_{j} - 3 / 2 ) {T}_{c}}{3 {T}_{c}} ) {\overline{b}}_{ij} ( t ) {\overline{a}}_{ij} ( t + 3 {T}_{c} ) {z}_{ij} ( t + 3 {T}_{c} ) + \\ Π ( \frac{t - {T}_{c}}{2 {T}_{c}} ) {\overline{b}}_{ij} ( t ) {\overline{c}}_{ij} ( t - 2 {T}_{c} ) {z}_{ij} ( t - 2 {T}_{c} ) + \\ Π ( \frac{t - ( {R}_{j} - 5 / 2 ) {T}_{c}}{5 {T}_{c}} ) {\overline{c}}_{ij} ( t ) {\overline{a}}_{ij} ( t + 5 {T}_{c} ) {z}_{ij} ( t + 5 {T}_{c} ) + \\ Π ( \frac{t - ( {R}_{j} - 1 ) {T}_{c}}{2 {T}_{c}} ) {\overline{c}}_{ij} ( t ) {\overline{b}}_{ij} ( t + 2 {T}_{c} ) {z}_{ij} ( t + 2 {T}_{c} )\end{matrix} \\ {I}_{ij} ( t ) = ( {MAI}_{ij} ( t ) + {IPI}_{ij} ( t ) ) / {B}_{ij} ( t ) ,\end{matrix} \\ where {B}_{ij} ( t ) = {\overline{a}}_{ij}^{2} ( t ) + {\overline{b}}_{ij}^{2} ( t ) + {\overline{c}}_{ij}^{2} ( t )\end{matrix} \qquad Eq . 7$$

The computed interference signals with Eq. 7 are removed from the normalized output signals xᵢⱼ of the rake receiver.

The signals rᵢⱼ(t), aᵢⱼ(t), bᵢⱼ(t), cᵢⱼ(t) are time delayed signals of r(t), a₀ⱼ(t), b₀ⱼ(t), c₀ⱼ(t) according to a processing delay upto the i^{th} interference canceller.

As mentioned above, the interference signals are removed at the i^{th} interference canceller and the interference subtracted signals are passed to the filter matched to the desired walsh code and scrambling code. Then, the output signals of the matched filter are passed to the i+1^{th} interference canceller.

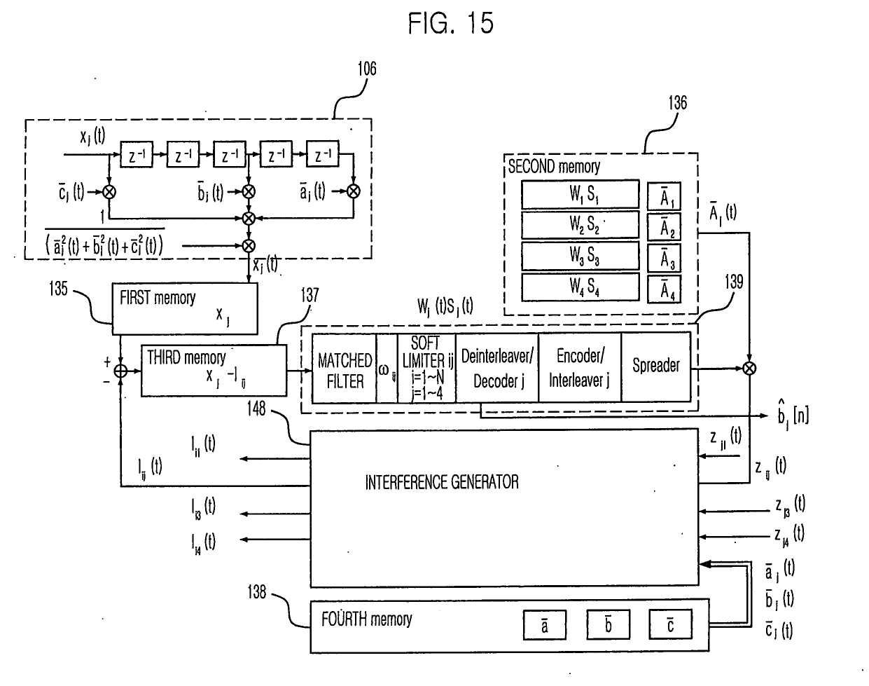

FIG. 15 is a block diagram showing the interference canceller having a feedback structure in accordance with the present invention. Because a plurality of interference cancellers repeat the same function at each stage, the multistage adaptive partial PIC can be implemented in a simple structure by storing the output signals of the rake receiver and using the stored signals repeatedly.

Referring to FIG. 15, the signal xⱼ outputted from the rake receiver 106 is stored in the first memory 135. The second memory 136 stores the Walsh code Wⱼ of each channel, the scrambling code Sⱼ and the magnitudes Aⱼ of signal received at each channel.

The interference signals Iᵢⱼ computed by the interference generator 148 are removed from the signal xⱼ outputted from the rake receiver and the interference-removed signal is stored in the third memory 137. Also, the fourth memory 138 stores the tap gains a, b and c outputted from the channel estimator.

A signal processing unit 139 could be a device packaged by the application specific integrated circuit (ASIC) or the digital signal processor (DSP). The signal processing unit 139 includes a matched filter, a weighting controller, a soft limiter, a deinterleaver/decoder, a encoder/interleaver and a spreader, and executes each function subsequently.

An operation process of the interference canceller of FIG. 15 is the same as that of Fig. 14. That is, the interference signals Iᵢⱼ computed by the interference generator 148 are removed from the signal xⱼ outputted from the rake receiver and the interference-removed signal is stored in the third memory 137. The signal stored in the third memory 137 is inputted to the signal processing unit 139.

The signal processing unit 139 executes the functions of the matched filter, the weighting controller, the soft limiter, the deinterleaver/decoder, the encoder/interleaver and the spreader, outputs the signal to the interference generator 148. Herein, the spreader of the signal processing unit 139 re-spreads the received signal by using the walsh code Wⱼ of each channel, the scrambling code Sⱼ and the magnitudes Aⱼ of a received signal at each channel stored in the second memory 136.

The interference generator 148 more precisely computes the interference signals by using the re-spread signal and the tap gains stored in the fourth memory 138. The computed interference signals are removed from the signal xⱼ outputted from the rake receiver 106 and stored in the first memory 135. As the feedback is repeated, the more precise interference signals are computed. If the interference signals are converged, the converged interference signals are removed from the signal outputted from the rake receiver and the desired user's information bits are extracted.

Therefore, the disadvantage of the nonlinear MUD is overcome by using the feedback structure and the circuit complexity can be drastically reduced.

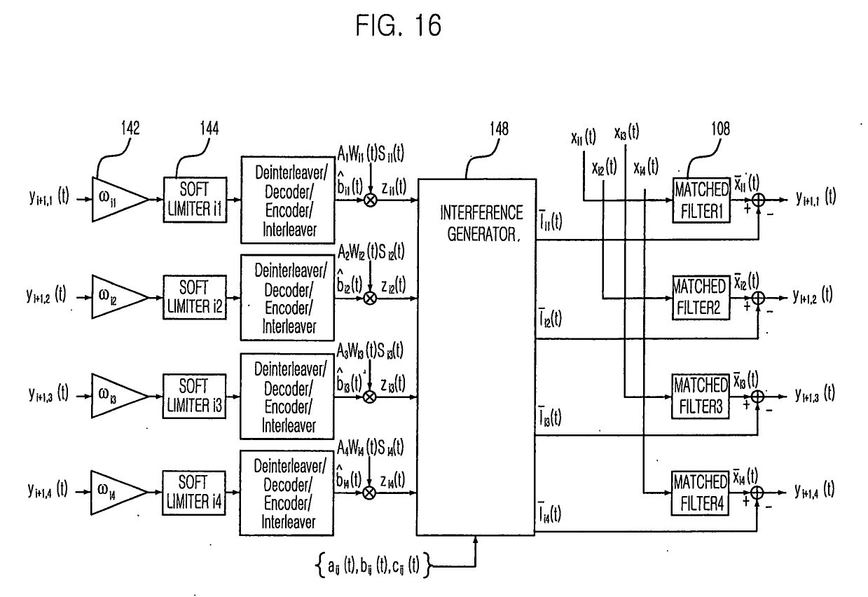

FIG. 16 is a block diagram showing a multistage adaptive partial PIC in accordance with another embodiment of the present invention.

Although an operation process of the multistage adaptive partial PIC of FIG. 16 is similar to that of FIG. 14, computation process of interference signal is modified and the interference signal is removed at the output port of the matched filer 108. The circuit is more simplified by removing the interference signal at the output port of the matched filter.

The modified equation for computing the interference signals is expressed as:

$$\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}For j = 1 to 4 and i = 1 to N \\ {z}_{oij} ( t ) = ( {\overline{a}}_{ij} ( t ) {z}_{ij} ( t ) + {\overline{b}}_{ij} ( t - 3 {T}_{c} ) {z}_{ij} ( t - 3 {T}_{c} ) +\end{matrix} \\ {\overline{c}}_{ij} ( t - 5 {T}_{c} ) {z}_{ij} ( t - 5 {T}_{c} ) )\end{matrix} \\ {MAI}_{oij} ( t ) = {\sum }_{{l = 1}_{l \neq j}}^{4} {z}_{oil} ( t )\end{matrix} \\ {MAI}_{ij} ( t ) = ( {\overline{a}}_{ij} ( t ) {MAI}_{oij} ( t ) + {\overline{b}}_{ij} ( t ) {MAI}_{oij} ( t + 3 {T}_{c} ) +\end{matrix} \\ {\overline{c}}_{ij} ( t ) {MAI}_{oij} ( t + 5 {T}_{c} ) )\end{matrix} \\ {IPI}_{ij} ( t ) = Π ( \frac{t - 3 / 2 {T}_{c}}{3 {T}_{c c}} ) {\overline{a}}_{ij} ( t ) {\overline{b}}_{ij} ( t - 3 {T}_{c} ) {z}_{ij} ( t - 3 {T}_{c} ) +\end{matrix} \\ Π ( \frac{t - 5 / 2 {T}_{c}}{5 {T}_{c}} ) {\overline{a}}_{ij} ( t ) {\overline{c}}_{ij} ( t - 5 {T}_{c} ) {z}_{ij} ( t - 5 {T}_{c} ) +\end{matrix} \\ Π ( \frac{t - ( {R}_{j} - 3 / 2 ) {T}_{c}}{3 {T}_{c}} ) {\overline{b}}_{ij} ( t ) {\overline{a}}_{ij} ( t + 3 {T}_{c} ) {z}_{ij} ( t + 3 {T}_{c} ) +\end{matrix} \\ Π ( \frac{t - {T}_{c}}{2 {T}_{c}} ) {\overline{b}}_{ij} ( t ) {\overline{c}}_{ij} ( t - 2 {T}_{c} ) {z}_{ij} ( t - 2 {T}_{c} ) +\end{matrix} \\ Π ( \frac{t - ( {R}_{j} - 5 / 2 ) {T}_{c}}{5 {T}_{c}} ) {\overline{c}}_{ij} ( t ) {\overline{a}}_{ij} ( t + 5 {T}_{c} ) {z}_{ij} ( t + 5 {T}_{c} ) +\end{matrix} \\ Π ( \frac{t - ( {R}_{j} - 1 ) {T}_{c}}{2 {T}_{c}} ) {\overline{c}}_{ij} ( t ) {\overline{b}}_{ij} ( t + 2 {T}_{c} ) {z}_{ij} ( t + 2 {T}_{c} )\end{matrix} \\ {I}_{ij} ( t ) = ( {MAI}_{ij} ( t ) + {IPI}_{ij} ( t ) ) / {B}_{ij} ( t ) ,\end{matrix} \\ where {B}_{ij} ( t ) = {\overline{a}}_{ij}^{2} ( t ) + {\overline{b}}_{ij}^{2} ( t ) + {\overline{c}}_{ij}^{2} ( t )\end{matrix} \\ {\overline{I}}_{ij} ( t ) = \frac{1}{{R}_{j} {T}_{c}} {\int }_{0}^{{R}_{j} {T}_{c}} {I}_{ij} ( t ) {W}_{ij} ( t ) {S}_{ij} ( t ) ⅆ t\end{matrix} \qquad Eq . 8$$

The output signal xᵢⱼ is inputted to the matched filter 108 and the signal \overline{xᵢⱼ} is outputted. The interference signal \overline{Iᵢⱼ} computed in the interference generator 148 is removed from the signal \overline{xᵢⱼ}.

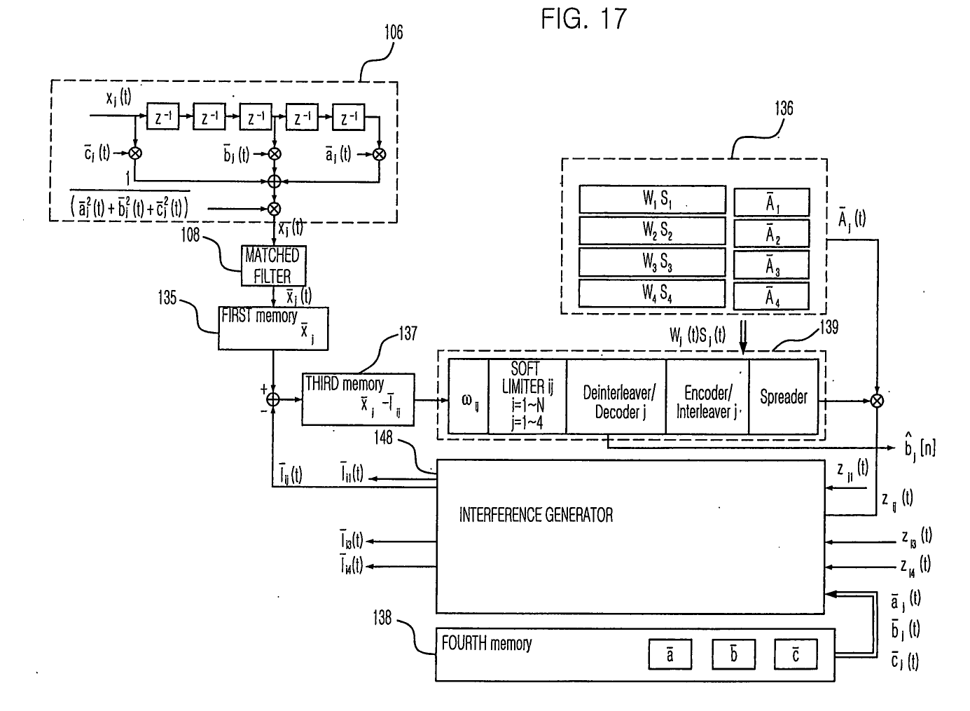

FIG. 17 is a block diagram showing the i^{th} interference canceller having a feedback structure in accordance with the present invention. The same reference numbers of FIG. 15 are used in FIG. 17 because the functions of the units are the same.

Referring to FIG. 17, the signal xⱼ outputted from the rake receiver 106 is inputted to the matched filter 108 and the matched filter output signal \overline{xⱼ} is stored in the first memory 135.

The interference signal \overline{Iᵢⱼ} computed by the interference generator 148 is removed from the matched filter output signal \overline{xⱼ} stored in the first memory 135 and the interference-removed signal is stored in the third memory 137. The interference-removed signal stored in the third memory 137 is inputted to the signal processing unit 139.

The signal processing unit 139 includes the matched filter, a weighting controller, a soft limiter, a deinterleaver/decoder, a encoder/interleaver, and a spreader, and executes each function subsequently. Herein, the spreader of the signal processing unit 139 re-spreads the received signal by using the Walsh code Wⱼ of each channel, the scrambling code Sⱼ and the magnitudes Aⱼ of a received signal at each channel stored in the second memory 136.

The interference generator 148 more precisely computes the interference signals by using the re-spread signal and the tap gains stored in the fourth memory 138. The computed interference signal is removed from the signal \overline{xⱼ} outputted from the matched filter 108 and stored in the first memory 135. As the feedback is repeated, the more precise interference signals are computed. If the interference signals are converged, the converged interference signals are removed from the signal outputted from the rake receiver and the desired user's information bits are extracted.

<Simulation Results>

The performance of the invented multistage adaptive partial PIC are evaluated for the uplink channels which are assumed to have the system parameters summarized in Table 1.

TABLE 1

| Items | Parameters |
|---|---|
| Number of users | 3-4 |
| Multiple-access | DS-CDMA |
| mode | |
| Chip rate | 3.84 Mcps |
| Modulation | BPSK |
| Spreading code | Short Scrambling Code(Length: 256) |
| | Walsh code |
| Spreading gain | 4 |
| Channel coding | Turbo Code, Coding Rate 1/3, |
| Channel model | COST207. model for urban area |
| | 3 - path channel assumed |
| | (path delay: 0T_{c}, 1 T_{c}, 2 T_{c}) |

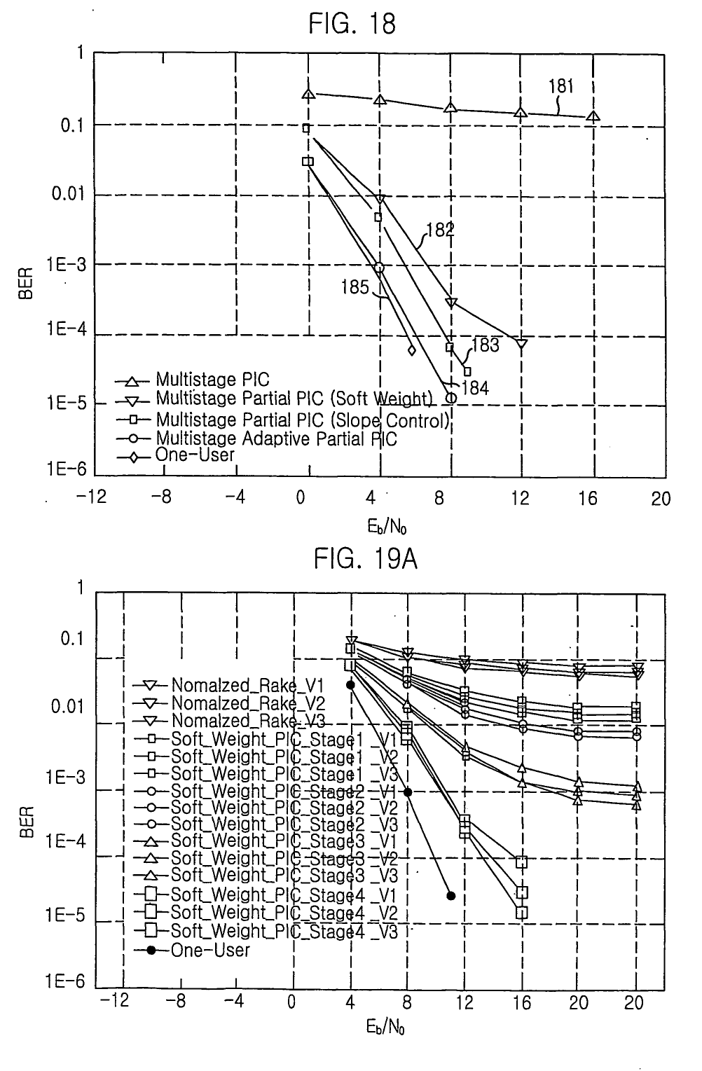

The performance of the conventional PIC, the existing multistage partial PICs, and the multistage adaptive partial PIC of the present invention are compared in FIG. 18.

The reference number 181 represents a performance of the conventional multistage PIC and the reference number 182 illustrates a performance of the five-stage partial PIC which consists of fixed slope soft limiters followed by the weighting units. The weight values of each stage are chosen as the ones that show the best BER performance at the last stage by test. The reference number 183 shows a performance of the five-stage partial PIC which includes only soft limiters. The slopes of each stage are chosen as the ones that show the best BER performance by test. The reference number 184 shows a performance of a two-stage adaptive partial PIC of the present invention.

Referring to FIG. 18, the two-stage adaptive partial PIC of the present invention outperforms the conventional multistage PIC and existing five-stage partial PICs. When bit error rate (BER) is assumed as 10⁻³, an obtained gain is 2-3 dB and the performance of the present invention is almost same as an optimal performance 185 of single user channel which has no MAI.

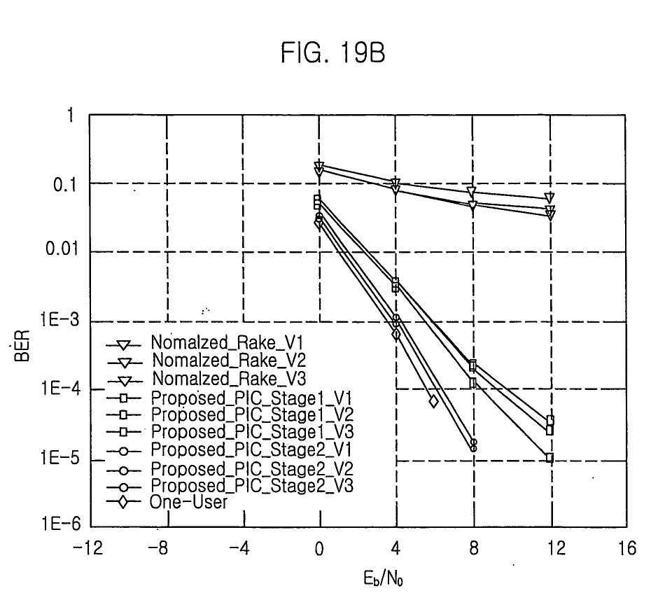

FIG. 19A shows a performance of a multistage partial PIC controlling weighting values at each stage and slopes of soft limiters; and FIG. 19B depicts a performance of an adaptive multistage partial PIC of the present invention.

Referring to FIGS. 19A and 19B, the performance of the multistage partial PIC can be enhanced and the error floor problem can be solved more efficiently by adaptively controlling the only slopes of the soft limiters than multistage partial PIC which controls the slopes of the soft limiters and the weighting values together.

As mentioned above, with the present invention MAI and IPI on the time varying fading channel can be removed by adaptively controlling the slope of the soft limiter with the weighting controller cascaded to the soft limiter.

Also, the degradation of orthogonality among user signals is minimized by normalizing the output signals of the rake receiver with the sum of squared path gains obtained from the channel estimator.

Also, the circuit complexity can be reduced by storing the output signals of the rake receiver or the matched filter in the memory and canceling the estimated interference from the stored values with the feedback structured recursive adaptive partial PIC.

While the present invention has been shown and described with respect to the particular embodiments, it will be apparent to those skilled in the art that many changes and modifications may be made without departing from the spirit and scope of the invention as defined in the appended claims.

What is claimed is:

1. A multistage adaptive partial parallel interference canceller (PIC) in a downlink receiver having a plurality of channels, for removing multiple access interference (MAI) and interpath interference (IPI), comprising:
a filter matched to a desired walsh code and a scrambling code for despreading and integrating output signals of a rake receiver;
a soft limiter for performing soft decisions and generating a soft-limited signal;
a weighting control means cascaded to the soft limiter for controlling a slope of the soft limiter;
a re-spreading means for respreading the soft-limited signal outputted from the soft limiter based on a walsh code and a scrambling code, and generating a re-spread signal;
an interference generator for computing MAI and IPI included in the signal received at the rake receiver; and
an interference signal removing means for removing the MAI and IPI from a signal received at the rake receiver.

2. The apparatus as recited in claim 1, wherein the interference canceller of each stage includes:
a normalizing means for normalizing the signal outputted from the rake receiver by using a sum of squared path gains of each finger of the rake receiver.

3. The apparatus as recited in claim 2, wherein the soft limiter performs the soft decisions based upon equation expressed as:
$$tanh ( ω U ) = \frac{{ⅇ}^{ω U} - {ⅇ}^{ω U}}{{ⅇ }^{ω U} + {ⅇ}^{ω U}} ,$$
wherein ω denotes the slope at the origin of the function and U represents an input signal.

4. The apparatus as recited in claim 3, wherein the weighting control means controls the slope ω based on LMS algorithm.

5. The apparatus as recited in claim 3, wherein the weighting control means controls the slope ω based on average to variance ratio estimation algorithm.

6. The apparatus as recited in claim 1, wherein the interference generating means computes the interference signals based upon equation expressed as:
$$\begin{matrix}\begin{matrix}\begin{matrix}\begin{matrix}For i = 1 to N and j = 1 to 4 \\ {z}_{i} ( t ) = {\sum }_{j = 1}^{4} {z}_{ij} ( t ) \end{matrix} \\ {IPI}_{ai} ( t ) = {\overline{b}}_{i} ( t - {lT}_{c} ) {z}_{i} ( t - {lT}_{c} ) + {\overline{c}}_{i} ( t - {mT}_{c} ) {z}_{i} ( t - {mT}_{c} )\end{matrix} \\ {IPI}_{bi} ( t ) = {\overline{a}}_{i} ( t + {lT}_{c} ) {z}_{i} ( t + {lT}_{c} ) + {\overline{c}}_{i} ( t - ( m - l ) {T}_{c} ) {z}_{i} ( t - ( m - l ) {T}_{c} )\end{matrix} \\ {IPI}_{ci} ( t ) = {\overline{a}}_{i} ( t + {mT}_{c} ) {z}_{i} ( t + {mT}_{c} ) + {\overline{b}}_{i} ( t + ( m - l ) {T}_{c} ) {z}_{i} ( t + ( m - l ) {T}_{c} )\end{matrix}$$
wherein a(t), b(t) and c(t) are path gains of each finger of the rake receiver, z(t) is the respread signal, 1/T_{c} is a chip rate, and 1T_{c} and mT_{c} are the propagation delays of the 2nd and 3rd paths.

7. The apparatus as recited in claim 6, wherein the interference generating means computes a compensation signal based upon equation expressed as:
$$\begin{matrix}\begin{matrix}\begin{matrix}\begin{matrix}\begin{matrix}\begin{matrix}\begin{matrix}{IPS}_{ij}^{′} ( t ) = Π ( \frac{t - ( {R}_{j} + l ) {T}_{c} / 2}{( {R}_{j} - l ) {T}_{c}} ) \overline{{a}_{i}} ( t ) \overline{{b}_{i}} ( t - {lT}_{c} ) {z}_{ij} ( t - {lT}_{c} ) + \\ Π ( \frac{t - ( {R}_{j} + m ) {T}_{c} / 2}{( {R}_{j} - m ) {T}_{c}} ) \overline{{a}_{i}} ( t ) \overline{{c}_{i}} ( t - {mT}_{c} ) {z}_{ij} ( t - {mT}_{c} ) +\end{matrix} \\ Π ( \frac{t - ( {R}_{j} - l ) {T}_{c} / 2}{( {R}_{j} - l ) {T}_{c}} ) \overline{{b}_{i}} ( t ) \overline{{a}_{i}} ( t + {lT}_{c} ) {z}_{ij} ( t + {lT}_{c} ) +\end{matrix} \\ Π ( \frac{t - ( {R}_{j} + ( m - l ) ) {T}_{c} / 2}{( {R}_{j} - ( m - l ) ) {T}_{c}} ) \overline{{b}_{i}} ( t ) \overline{{c}_{i}} ( t - ( m - l ) {T}_{c} ) {z}_{ij} ( t - ( m - l ) {T}_{c} ) +\end{matrix} \\ Π ( \frac{t - ( {R}_{j} - m ) {T}_{c} / 2}{( {R}_{j} - m ) {T}_{c}} ) \overline{{c}_{i}} ( t ) \overline{{a}_{i}} ( t + {mT}_{c} ) {z}_{ij} ( t + {mT}_{c} ) +\end{matrix} \\ Π ( \frac{t - ( {R}_{j} + ( m - l ) ) {T}_{c} / 2}{( {R}_{j} - ( m - l ) ) {T}_{c}} ) \overline{{c}_{i}} ( t ) \overline{{b}_{i}} ( t + ( m - l ) {T}_{c} ) {z}_{ij} ( t + ( m - l ) {T}_{c} ) ,\end{matrix} \\ {IPS}_{ij} ( t ) = {IPS}_{ij} ( t ) / {B}_{i} ( t ) where\end{matrix} \\ {B}_{i} ( t ) = {\overline{a}}_{i}^{2} ( t ) + {\overline{b}}_{i}^{2} ( t ) + {\overline{c}}_{i}^{2} ( t )\end{matrix}$$
wherein Rⱼ is a spreading gain and the interference canceller of each stage further includes:
a signal compensation means for adding the compensation signal with an interference-removed signal.

8. The apparatus as recited in claim 1, further including:
a deinterleaver/decoder for correcting an error of a signal; and
an interleaver/encoder for interleaving and encoding.

9. A multistage adaptive partial parallel interference canceller (PIC) in a downlink receiver having a plurality of channels, for removing multiple access interference (MAI) and interpath interference (IPI), comprising:
a filter matched to a desired walsh code and a scrambling code for despreading and integrating output signal of a rake receiver;
a soft limiter for performing a soft decisions and generating a soft-limited signal;
a weighting control means cascaded to the soft limiter for controlling a slope of the soft limiter;
a re-spreading means for respreading the soft-limited signal outputted from the soft limiter based on a walsh code and a scrambling code, and generating a re-spread signal;
an interference generator for computing MAI and IPI included in the output signal of the rake receiver; and
an interference signal removing means for removing the MAI and IPI from the output signal of the rake receiver.

10. The apparatus as recited in claim 9, wherein the interference canceller of each stage includes:
a normalizing means for normalizing the signal outputted from the rake receiver by using a sum of squared path gains of each finger of the rake receiver.

11. The apparatus as recited in claim 10, wherein the soft limiter performs the soft decision based upon equation expressed as:
$$tanh ( ω U ) = \frac{{ⅇ}^{ω U} - {ⅇ}^{ω U}}{{ⅇ}^{ω U} + {ⅇ}^{ω U}} ,$$
wherein ω denotes the slope at the origin of the function and U represents an input signal.

12. The apparatus as recited in claim 11, wherein the weighting control means controls the slope ω based on LMS algorithm.

13. The apparatus as recited in claim 11, wherein the weighting control means controls the slope ω based on average to variance ratio estimation algorithm.

14. The apparatus as recited in claim 9, wherein the interference generating means computes the interference signals based upon equation expressed as:
$$\begin{matrix}For i = 1 ∼ N and j = 1 ∼ 4 \\ {z}_{i} ( t ) = {\sum }_{j = 1}^{4} {z}_{ij} ( t )\end{matrix}$$
$${IPI}_{i}^{′} ( t ) = {\overline{a}}_{i} ( t ) ( {\overline{b}}_{i} ( t - {lT}_{c} ) {z}_{i} ( t - {lT}_{c} ) + {\overline{c}}_{i} ( t - {mT}_{c} ) {z}_{i} ( t - {mT}_{c} ) ) + {\overline{b}}_{i} ( t ) ( {\overline{a}}_{i} ( t + {lT}_{c} ) {z}_{i} ( t + {lT}_{c} ) + {\overline{c}}_{i} ( t - ( m - l ) {T}_{c} ) {z}_{i} ( t - ( m - l ) {T}_{c} ) ) + {\overline{c}}_{i} ( t ) ( {\overline{a}}_{i} ( t + {mT}_{c} ) {z}_{i} ( t + {mT}_{c} ) + {\overline{b}}_{i} ( t + ( m - l ) {T}_{c} ) {z}_{i} ( t + ( m - l ) {T}_{c} ) )$$
$$\begin{matrix}{B}_{i} ( t ) = {\overline{a}}_{i}^{2} ( t ) + {\overline{b}}_{i}^{2} ( t ) + {\overline{c}}_{i}^{2} ( t ) \\ {IPI}_{i} ( t ) = {IPI}_{i}^{′} ( t ) / {B}_{i} ( t ) ,\end{matrix}$$
wherein a(t), b(t) and c(t) are gains of each of the rake receiver, z(t) is the respread signal, 1/T_{c} is a chip rate, and 1T_{c} and mT_{c} are the propagation delays of the 2nd and 3rd paths.

15. The apparatus as recited in claim 14, wherein the interference generating means computes a compensation signal IPS based upon equation expressed as:
$${IPS}_{ij}^{ ′} ( t ) = Π ( \frac{t - ( {R}_{j} + l ) {T}_{c} / 2}{( {R}_{j} - l ) {T}_{c}} ) {\overline{a}}_{i} ( t ) {\overline{b}}_{i} ( t - {lT}_{c} ) {z}_{ij} ( t - {lT}_{c} ) + Π ( \frac{t - ( {R}_{j} + m ) {T}_{c} / 2}{( {R}_{j} - m ) {T}_{c}} ) {\overline{a}}_{i} ( t ) {\overline{c}}_{i} ( t - {mT}_{c} ) {z}_{ij} ( t - {mT}_{c} ) + Π ( \frac{t - ( {R}_{j} + l ) {T}_{c} / 2}{( {R}_{j} - l ) {T}_{c}} ) {\overline{b}}_{i} ( t ) {\overline{a}}_{i} ( t + {lT}_{c} ) {z}_{ij} ( t + {lT}_{c} ) + Π ( \frac{t - ( {R}_{j} + ( m - l ) ) {T}_{c} / 2}{( {R}_{j} - ( m - l ) ) {T}_{c}} ) {\overline{b}}_{i} ( t ) {\overline{c}}_{i} ( t - ( m - l ) {T}_{c} ) {z}_{ij} ( t - ( m - l ) {T}_{c} ) + Π ( \frac{t - ( {R}_{j} + m ) {T}_{c} / 2}{( {R}_{j} - m ) {T}_{c}} ) {\overline{c}}_{i} ( t ) {\overline{a}}_{i} ( t + {mT}_{c} ) {z}_{ij} ( t + {mT}_{c} ) + Π ( \frac{t - ( {R}_{j} ( m - l ) ) {T}_{c} / 2}{( {R}_{j} - ( m - l ) ) {T}_{c}} ) {\overline{c}}_{i} ( t ) {\overline{b}}_{i} ( t + ( m - l ) {T}_{c} ) {z}_{ij} ( t + ( m - l ) {T}_{c} ) , \\ {IPS}_{ij} ( t ) = {IPS}_{ij}^{′} ( t ) / {B}_{i} ( t ) where {B}_{i} ( t ) = {\overline{a}}_{i}^{2} ( t ) + {\overline{b}}_{i}^{2} ( t ) + {\overline{c}}_{i}^{2} ( t )$$
wherein Rⱼ is a spreading gain and the interference canceller of each stage further includes:
a signal compensation means for adding the compensation signal with an interference-removed signal.

16. The apparatus as recited in claim 9, further including:
a deinterleaver/decoder for correcting an error of a signal; and
an interleaver/encoder for interleaving and encoding.

17. A multistage adaptive partial parallel interference canceller (PIC) in an uplink receiver having a plurality of channels, for removing multiple access interference (MAI) and interpath interference (IPI), comprising:
a filter matched to the desired walsh code and scrambling code for despreading and integrating an output signal of the rake receiver;
a soft limiter for performing & soft decisions and generating a soft-limited signal;
a weighting control means cascaded to the soft limiter for controlling a slope of the soft limiter;
a re-spreading means for respreading the soft-limited signal outputted from the soft limiter based on a walsh code and a scrambling code, and generating a re-spread signal;
an interference generator for computing MAI and IPI included in the signal received at the output of rake receiver; and
an interference signal removing means for removing the MAI and IPI from a signal received at the rake receiver.

18. The apparatus as recited in claim 17, wherein the interference canceller of each stage includes:
a normalizing means for normalizing the signal outputted from the rake receiver by using a sum of squared path gains of each finger of the rake receiver.

19. The apparatus as recited in claim 18, wherein the soft limiter performs the soft decision based upon equation expressed as:
$$tanh ( ω U ) = \frac{{ⅇ}^{ω U} - {ⅇ}^{ω U}}{{ⅇ}^{ω U} + {ⅇ}^{ω U}} ,$$
wherein ω denotes the slope at the origin of the function and U represents an input signal.

20. The apparatus as recited in claim 19, wherein the weighting control means controls the slope ω based on LMS algorithm.

21. The apparatus as recited in claim 19, wherein the weighting control means controls the slope ω based on average to variance ratio estimation algorithm.

22. The apparatus as recited in claim 17, wherein the interference generating means computes the interference signals based upon equation expressed as:
$$For j = 1 to 4 and i = 1 to N$$
$${z}_{oij} ( t ) = ( {\overline{a}}_{ij} ( t ) {z}_{ij} ( t ) + {\overline{b}}_{ij} ( t - {lT}_{c} ) {z}_{ij} ( t - {lT}_{c} ) + {\overline{c}}_{ij} ( t - {mT}_{c} ) {z}_{ij} ( t - {mT}_{c} ) )$$
$${MAI}_{oij} ( t ) = {{\sum }_{l = 1}^{4}}_{l \neq 1} {z}_{oil} ( t )$$
$${MAI}_{ij} ( t ) = ( {\overline{a}}_{ij} ( t ) {MAI}_{oij} ( t ) + {\overline{b}}_{ij} ( t ) {MAI}_{oij} ( t + {lT}_{c} ) + {\overline{c}}_{ij} ( t ) {MAI}_{oij} ( t + {mT}_{c} ) )$$
$${IPI}_{ij} ( t ) = Π ( \frac{t - \frac{l}{2} {T}_{c}}{3 {T}_{c}} ) {\overline{a}}_{ij} ( t ) {\overline{b}}_{ij} ( t - {lT}_{c} ) {z}_{ij} ( t - {lT}_{c} ) + Π ( \frac{t - \frac{m}{2} {T}_{c}}{{mT}_{c}} ) {\overline{a}}_{ij} ( t ) {\overline{c}}_{ij} ( t - {mT}_{c} ) {z}_{ij} ( t - {mT}_{c} ) + Π ( \frac{t - ( {R}_{j} - \frac{l}{2} ) {T}_{c}}{{lT}_{c}} ) {\overline{b}}_{ij} ( t ) {\overline{a}}_{ij} ( t + {lT}_{c} ) {z}_{ij} ( t + {lT}_{c} ) + Π ( \frac{t - \frac{( m - l )}{2} {T}_{c}}{( m - l ) {T}_{c}} ) {\overline{b}}_{ij} ( t ) {\overline{c}}_{ij} ( t - ( m - l ) {T}_{c} ) {z}_{ij} ( t - ( m - l ) {T}_{c} ) + ( \frac{t - ( {R}_{j} - \frac{m}{2} ) {T}_{c}}{{mT}_{c}} ) {\overline{c}}_{ij} ( t ) {\overline{a}}_{ij} ( t + {mT}_{c} ) {z}_{ij} ( t + {mT}_{c} ) + Π ( \frac{t - ( {R}_{j} - \frac{( m - l )}{2} ) {T}_{c}}{( m - l ) {T}_{c}} ) {\overline{c}}_{ij} ( t ) {\overline{b}}_{ij} ( t + ( m - l ) {T}_{c} ) {z}_{ij} ( t + ( m - l ) {T}_{c} )$$
$${I}_{ij} ( t ) = ( {MAI}_{ij} ( t ) + {IPI}_{ij} ( t ) ) / {B}_{ij} ( t ) , where$$
$${B}_{ij} ( t ) = {\overline{a}}_{ij}^{2} ( t ) + {\overline{b}}_{ij}^{2} ( t ) + {\overline{c}}_{ij}^{2} ( t ) ,$$
wherein a(t), b(t) and c(t) are path gains of each finger of the rake receiver, z(t) is the respread signal,. 1/T_{c} is a chip rate, and 1T_{c} and mT_{c} are the propagation delays of the 2nd and 3rd paths.

23. The apparatus as recited in claim 22, further including:
a deinterleaver/decoder for correcting an error of a signal; and
an interleaver/encoder for interleaving and encoding.

24. A multistage adaptive partial parallel interference canceller (PIC) in an uplink receiver having a plurality of channels, for removing multiple access interference (MAI) and interpath interference (IPI), comprising:
a soft limiter for performing a soft decisions and generating a soft-limited signal;
a weighting control means cascaded to the soft limiter for controlling the slope of the soft limiter;
a re-spreading means for respreading the soft-limited signal outputted from the soft limiter based on a walsh code and a scrambling code, and generating a re-spread signal;
an interference generator for computing MAI and IPI included in the output signal of the matched filter;
a filter matched to a desired walsh code and a scrambling code for despreading and integrating the output signals of a rake receiver; and
an interference signal removing means for removing the MAI and IPI from an output signal of the filter.

25. The apparatus as recited in claim 24, wherein the interference canceller of each stage includes:
a normalizing means for normalizing the signal outputted from the rake receiver by using a sum of squared path gains of each finger of the rake receiver.

26. The apparatus as recited in claim 25, wherein the soft limiter performs the soft decision based upon equation expressed as:
$$tanh ( ω U ) = \frac{{ⅇ}^{ω U} - {ⅇ}^{ω U}}{{ⅇ}^{ω U} + {ⅇ}^{ω U}} ,$$
wherein ω denotes the slope at the origin of the function and U represents an input signal.

27. The apparatus as recited in claim 26, wherein the weighting control means controls the slope ω based on LMS algorithm.

28. The apparatus as recited in claim 26, wherein the weighting control means controls the slope ω based on average to variance ratio estimation algorithm.

29. The apparatus as recited in claim 24, wherein the interference generating means computes the interference signals based upon equation expressed as:
$$For j = 1 to 4 and i = 1 to N$$
$${z}_{oij} ( t ) = ( {\overline{a}}_{ij} ( t ) {z}_{ij} ( t ) + {\overline{b}}_{ij} ( t - {lT}_{c} ) {z}_{ij} ( t - {lT}_{c} ) + {\overline{c}}_{ij} ( t - {mT}_{c} ) {z}_{ij} ( t - {mT}_{c} ) )$$
$${MAI}_{oij} ( t ) = {{\sum }_{l = 1}^{4}}_{l \neq 1} {z}_{oil} ( t )$$
$${MAI}_{ij} ( t ) = ( {\overline{a}}_{ij} ( t ) {MAI}_{oij} ( t ) + {\overline{b}}_{ij} ( t ) {MAI}_{oij} ( t + {lT}_{c} ) + {\overline{c}}_{ij} ( t ) {MAI}_{oij} ( t + {mT}_{c} ) )$$
$${IPI}_{ij} ( t ) = Π ( \frac{t - \frac{l}{2} {T}_{c}}{{lT}_{c}} ) {\overline{a}}_{ij} ( t ) {\overline{b}}_{ij} ( t - {lT}_{c} ) {z}_{ij} ( t - {lT}_{c} ) + Π ( \frac{t - \frac{m}{2} {T}_{c}}{{mT}_{c}} ) {\overline{a}}_{ij} ( t ) {\overline{c}}_{ij} ( t - {mT}_{c} ) {z}_{ij} ( t - {mT}_{c} ) + Π ( \frac{t - ( {R}_{j} - \frac{l}{2} ) {T}_{c}}{{lT}_{c}} ) {\overline{b}}_{ij} ( t ) {\overline{a}}_{ij} ( t + {lT}_{c} ) {z}_{ij} ( t + {lT}_{c} ) + Π ( \frac{t - ( m - l ) \frac{( m - l )}{2} {T}_{c}}{2 {T}_{c}} ) {\overline{b}}_{ij} ( t ) {\overline{c}}_{ij} ( t - ( m - l ) {T}_{c} ) {z}_{ij} ( t - ( m - l ) {T}_{c} ) + ( \frac{t - ( {R}_{j} - \frac{m}{2} ) {T}_{c}}{{mT}_{c}} ) {\overline{c}}_{ij} ( t ) {\overline{a}}_{ij} ( t + {mT}_{c} ) {z}_{ij} ( t + {mT}_{c} ) + Π ( \frac{t - ( {R}_{j} - \frac{( m - l )}{2} ) {T}_{c}}{( m - l ) {T}_{c}} ) {\overline{c}}_{ij} ( t ) {\overline{b}}_{ij} ( t + ( m - l ) {T}_{c} ) {z}_{ij} ( t + ( m - l ) {T}_{c} )$$
$${I}_{ij} ( t ) = ( {MAI}_{ij} ( t ) + {IPI}_{ij} ( t ) ) / {B}_{ij} ( t ) , where$$
$${B}_{ij} ( t ) = {\overline{a}}_{ij}^{2} ( t ) + {\overline{b}}_{ij}^{2} ( t ) + {\overline{c}}_{ij}^{2} ( t )$$
wherein a(t), b(t) and c(t) are gains of each of the rake receiver, z(t) is the respread signal, 1/T_{c} is a chip rate, and 1T_{c} and mT_{c} are the propagation delays of the 2nd and 3rd paths.

30. The apparatus as recited in claim 22, further including:
a deinterleaver/decoder for correcting an error of a signal; and
an interleaver/encoder for interleaving and encoding.
